(19) United States
(12) Patent Application Publication
(10) Pub. No.: US 2004/0017481 A1
(43) Pub. Date: Jan. 29, 2004

(54) Digital camera, image pickup method, and image format conversion method

(75) Inventors: Shinya Takasumi, Tokyo (JP); Tetsuya Kokufu, Tokyo (JP); Hitoshi Hashimoto, Tokyo (JP)

Correspondence Address: VOLPE AND KOENIG, P.C., UNITED PLAZA, SUITE 1600, 30 SOUTH 17TH STREET, PHILADELPHIA, PA, 19103, US

(73) Assignee: Olympus Optical Co., Ltd., Tokyo (JP)

(21) Appl. No.: 10/408,958

(22) Filed: Apr. 8, 2003

(30) Foreign Application Priority Data
Apr. 11, 2002 (JP) 2002-109664
Apr. 17, 2002 (JP) 2002-115255
Aug. 19, 2002 (JP) 2002-238401

(51) Int. Cl. H04N 5/225

(52) U.S. Cl. 348/207.99

(57) ABSTRACT

Upon a photographer selecting and setting a desired trimming form from various trimming forms prepared beforehand, an image regarding which shooting is planned can be displayed on a display unit 31 in a state with the selected trimming form applied to the image by a first signal processing unit within the system controller 18, and in the event of subsequently performing shooting (recording) activation operations such as releasing or the like, image signals to which trimming is not applied and identification signals representing the trimming form selected at that time can be recorded on a recording medium 23 by a second signal processing unit in the system controller 18. At the time of reproducing, the image signals recorded in the recording medium 23 can be reproduced in a state with the trimming form corresponding thereto applied.

This application claims benefit of Japanese Application No. 2002-109664 filed in Japan on Apr. 11, 2002, Japanese Application No. 2002-115255 filed in Japan on Apr. 17, 2002 and Japanese Application No. 2002-238401 filed in Japan on Aug. 19, 2002, the contents of which are incorporated by this reference.

### BACKGROUND OF THE INVENTION

1. Field of the Invention

The present invention relates to a digital camera, an image pickup method, and an image format conversion method, and particularly to a method for processing recorded images, an exposure control method, and an image generating method for generating image data to be recorded based upon original image data temporarily stored in buffer memory.

2. Description of the Related Art

In recent years, arrangements are being developed wherein a system configured with a digital camera and printer device is connected, and images shot by the digital camera are printed out in various forms. As an example, a system wherein a digital camera and a printer device are connected without introducing a personal computer therebetween and printing can be performed in various forms is disclosed in Japanese Unexamined Patent Application Publication No. 10-108005. Furthermore, an arrangement as described below is disclosed as an example thereof. That is to say, printer device operating image data is stored in memory provided in a printer device, the stored data is transmitted to a digital camera side, and a display unit of the digital camera side displays printer device operational images having multiple format selective images. Next, an operator selects one format from the multiple formats (image display formats) while watching the operational images, and furthermore, selects a photographic image from the digital camera. The photographic image is printed with the format image thus selected.

On the other hand, the present assignee has previously proposed a system including a digital camera and a printer for printing an image taken by the digital camera (Japanese Unexamined Patent Application Publication No. 10-200850). In the proposal, an image selected as an image to be printed is displayed on a display unit of the digital camera so that the operator can confirm the image, and the data of image confirmed by the operator is transmitted to the printer side. With the configuration as described above, the operator can easily select and confirm an image for printing, and print the desired image in a sure manner.

On the other hand, with an image pickup device such as a digital camera which employs a CCD having the vertical overflow structure as an image pickup device, a technique for controlling exposure for the image pickup device, i.e., an electronic shutter disclosed in Japanese Unexamined Patent Application Publication No. 11-8802, and Japanese Unexamined Patent Application Publication No. 6-62323 is known. With the technique, the charges accumulated in a photoelectric conversion unit are discharged to a substrate side and next accumulation of charges is begun by applying voltage to a substrate bias, and exposure is controlled by controlling the duration from a point in time of beginning of accumulation up to a point in time of transmitting of the charges accumulated in the photoelectric conversion unit (charge accumulation time or exposure time) to a vertical transmission unit.

On the other hand, while there are digital cameras for taking still images of subjects and recording the still images in a recording unit such as a recording media as digital data, there are various digital cameras having additional functions wherein moving images can be taken in digital data. These arrangements can be made due to increased speed of signal processing, small-sized memory, and advanced data-compression techniques, in recent years.

In general, the functions wherein moving images are taken in digital data are functions mainly for digital video camera. However, the moving images taken by the digital video camera and those taken by the digital camera have different methods for generating digital data due to different use for the moving images which have been taken. In general, while moving images have a great quantity of data amount, there is the need to perform image shooting and reproducing under a hardware environment with data processing capacity being limited. Therefore, various types of data compression methods are employed in shooting moving images. With the data compression methods, moving images taken by a digital video camera and those by a digital camera have the different data compression methods according to different use.

A digital video camera takes moving images to be used as moving images per se, and accordingly, employs the high data-compression method, which is referred to as “MPEG”, wherein the difference data between the present frame and the preceding frame is recorded, e.g., the difference data between second frame and first frame is recorded for the second frame data, and the difference data between third frame and second frame is recorded for the third frame data. While the data-compression method is excellent for handling moving images as moving images per se, the method is not suitable for handling and editing for each frame.

On the contrary, digital camera takes moving images for handling each frame making up moving images with each frame being configured as a still image, and accordingly, employs the data-compression method, which is referred to as “motion JPEG”, which performs data compression for each frame in the same way as JPEG which is employed in normal still images, and the moving images are configured by reproducing chronologically each of frames shot with the data-compression method at the same intervals as in image shooting.

The moving images thus reproduced are preferably recorded with the same frame rate of 30 (frames/sec) as in image taking.

However, the latter, digital camera, is configured principally for taking still images, and with the sequential frame processing required in shooting moving images, the desired processing speed (frame rate) has not been obtained due to the limits of the small-sized hardware configurations and algorithms for software to compensate for this are not being developed fast enough. Accordingly, in the event of setting the frame rate for recording in image taking to the desired value, several problems occur.

In general, with a digital camera, first of all, the image of the subject is converted into electric signals by an image pickup device such as a CCD, and the electric signals are converted into digital data by an A/D conversion circuit after each processing in a gain adjustment circuit and noise removal processing circuit. The digital data is temporarily stored, for example, in a temporary memory unit such as DRAM (Dynamic Random Access Memory) having a limited storage area in digital data (original image data). The original image data is read out from the temporary memory unit, the image format is converted for displaying, for example, on a display unit such as a liquid crystal panel included in the digital camera main unit, and generated as through-image display image data (which will be referred to as displaying image data hereafter). Also, with the same original image data, the image format is converted for recording into the recording unit such as a memory card detachably mounted on the digital camera main unit, and is generated as image data for recording. Subsequently, the generated displaying image data is displayed on a display unit for each time, and the generated image data for recording is recorded in the recording unit at a predetermined timing. With image shooting for moving images, the processing is performed wherein images of the subject are sequentially acquired from the image pickup device, and the aforementioned image format conversion for displaying and recording are performed in a repeated manner.

### SUMMARY OF THE INVENTION

The present invention has the following features.

A digital camera according to a first invention comprises: an image pickup optical system for forming an image of a subject; an image pickup device for generating image signals corresponding to light projected to its own image pickup screen by the image pickup optical system; a trimming form selecting unit for selectively setting a trimming form which matches the object of use of an image to be recorded; a first signal processing unit for subjecting the output of the image pickup device to signal processing such that an image can be observed in the trimming form selectively set by the trimming form selecting unit, and supplying to an applied electronic display unit; a second signal processing unit for obtaining signals to be recorded suitable for recording to a recording medium, in a form wherein partial loss of the image relating to trimming by the first signal processing unit does not occur based on the output of the image pickup device, and being accompanied by trimming form identification signals representing the trimming form relating to the image which has been selectively set by the trimming form selecting unit; a recording action activation unit for recording the image signals, which are subjected to processing at the second signal processing unit in response to operation of a trigger unit, on an applied recording medium; and an image reproducing unit for reproducing the image signals recorded on the recording medium according to a form corresponding to the trimming form represented by the trimming form identification signals accompanying the image signals.

With the first invention, upon selecting and setting a desired trimming form from various types of trimming forms prepared beforehand, the operator can display on the display unit an image for which photography is planned in a state of the trimming form being applied by the first signal processing unit, and in the event of subsequently performing photography (recording) activation operations such as releasing or the like, image signals to which trimming is not applied and identification signals representing the trimming form selected at that time can be recorded on the recording medium by the second signal processing unit. At the time of reproducing, the image signals recorded in the recording medium can be reproduced in a state with the trimming form corresponding thereto applied.

A digital camera according to a second invention comprises a luminance calculating unit for obtaining subject luminance from imaging signals of the image pickup device, and a charge accumulation time control unit for forbidding to discharge the charge of the image pickup device by the charge discharging pulses in the event that the obtained subject luminance is lower than a predetermined value, so as to control the charge accumulation time of the image pickup device in time intervals which are integral multiples of the vertical transfer period. The digital camera preferably further comprises an exposure control unit for controlling the charge accumulation amount by amplification of output signals of the image pickup device or by diaphragm value, in the event that the charge accumulation time of the image pickup device is controlled in time intervals which are integral multiples of the vertical transfer period.

With the second invention, charge read-out pulses are output synchronously with the intervals of the vertical synchronizing signals, and charge discharging pulses are not output. This is due to the unneccessariness of discharge operations done away with by matching the shutter speed (exposure time) to the cycle of the vertical synchronizing signals. Accordingly, no charge discharging pulses are output in this operations, so the board bias voltage does not vary, and through-images with no noise can be obtained.

A digital camera according to a third invention comprises: a temporary storage unit for performing storing of image signals sequentially image-picked-up and for sequentially updating of the storage; an image format converting unit for performing image format conversion of the image signals stored to generate through-image display image data or recording image data; an image conversion conditions setting unit having settings wherein the number of images of the recording image data generated per unit time at the image format converting unit is greater than the number of images of through-image display image data generated per unit time at the image format converting unit; and a control unit for performing image format conversion of image signals stored in the temporary storage unit into the through-image display image data or the recording image data at the image format converting unit, based on the settings at the image conversion conditions setting unit.

Due to the above configuration, the types of image data generated by the image format converting unit can be arranged such that there is the number of recording image data is greater than that of display image data. Accordingly, the frame rate of the recording image data can be increased, so natural reproduction can be realized at the time of reproduction of the moving images.

A digital camera according to a fourth invention comprises a temporary storage unit for performing storing of image signals sequentially image-picked-up and for sequentially updating the storage, an image format converting unit for performing image format conversion of the image signals stored to generate through-image display image data or recording image data, an image conversion conditions setting unit having settings wherein the number of images of the recording image data generated per unit time at the image format converting unit is increased, by reducing the number of images of through-image display image data generated per unit time at the image format converting unit, and a control unit for performing image format conversion of image signals stored in the temporary storage unit into the through-image display image data or the recording image data in the image format converting unit, based on the settings at the image conversion conditions setting unit.

Due to this configuration, generation of the display image data can be reduced in the image format converting unit, and generation of recording image data can be increased. Accordingly, the frame rate of the recording image data can be increased, so reproduction can be realized naturally on the time of reproduction of the moving images.

A digital camera according to a fifth invention comprises a temporary storage unit for performing storing of image signals sequentially image-picked-up and for sequentially updating of the storage, an image format converting unit for performing image format conversion of the image signals stored to generate through-image display image data or recording image data, an image conversion conditions setting unit having settings for relatively changing the number of images of the recording image data generated per unit time at the image format converting unit and the number of images of through-image display image data generated per unit time at the image format converting unit, and a control unit for performing image format conversion of image signals stored in the temporary storage unit into the through-image display image data or the recording image data in the image format converting unit, based on the settings at the image conversion conditions setting unit.

Due to this configuration, the number of images of the display image data and recording image data generated in the image format converting unit can be relatively changed. Accordingly, the frame rate of the recording image data can be increased, so reproduction can be realized naturally on the time of reproduction of the moving images.

A digital camera according to a sixth invention comprises a temporary storage unit for performing storing of image signals sequentially image-picked-up and for sequentially updating of the storage, an image format converting unit for performing image format conversion of the image signals stored to generate through-image display image data or recording image data, an image conversion conditions setting unit having settings wherein, at the time of sequentially performing image format conversion of the stored image signals, a first image format conversion for performing sequential image format conversion into both the through-image display image data and the recording image data, and a second image format conversion for performing image format conversion of the stored image signals into only the recording image data, are performed in time-sequence, and a control unit for performing image format conversion of image signals stored in the temporary storage unit into the through-image display image data or the recording image data at the image format converting unit, based on the settings at the image conversion conditions setting unit.

Due to this configuration, recording image data can be generated for all image signals for generating display image data, and recording image data alone can be generated for the other predetermined image signals. Accordingly, the frame rate of the recording image data can be increased, so reproduction can be realized naturally on the time of reproduction of the moving images.

### BRIEF DESCRIPTION OF THE DRAWINGS

FIG. 1 is a block diagram of a digital camera according to a first embodiment of the present invention.

FIG. 2 is a rear view of the digital camera according to the first embodiment.

FIG. 3 is a diagram illustrating a shooting mask list in the event of selecting the “selection of shooting mask” which is a feature of the present invention, from items on the menu screen of the digital camera.

FIG. 4A is a diagram illustrating an example of LCD display in the event of selecting “square” as a shooting mask.

FIG. 4B is a diagram illustrating an example of LCD display in the event of selecting “CD-R” as a shooting mask.

FIG. 4C is a diagram illustrating an example of LCD display in the event of selecting “photograph for certificate” as a shooting mask.

FIG. 5A through FIG. 5D are diagrams illustrating editing the shooting masks “square”, “CD-R”, and “photograph for certificate”, in the event of selecting the “editing of shooting mask” which is a feature of the present invention, from items on the menu screen of the digital camera.

FIG. 5E and FIG. 5F are diagrams illustrating editing the shooting mask “rectangle” in the event of selecting the “editing of shooting mask” which is a feature of the present invention, from items on the menu screen of the digital camera.

FIG. 5G and FIG. 5H are diagrams illustrating editing the shooting mask “ellipse” in the event of selecting the “editing of shooting mask” which is a feature of the present invention, from items on the menu screen of the digital camera .

FIG. 6A is a diagram illustrating an example of a “mark display” in the event of selecting and okaying “divided display” from the menu items of the digital camera, at the time of reproducing recorded images.

FIG. 6B is a diagram illustrating an example of a “solid display” in the event of selecting and okaying “divided display” from the menu items of the digital camera, at the time of reproducing recorded images.

FIG. 7A is a diagram illustrating an example of a “mark display” in the event of selecting and okaying “single frame display” from the menu items of the digital camera, at the time of reproducing recorded images.

FIG. 7B is a diagram illustrating an example of a “solid display” in the event of selecting and okaying “single frame display” from the menu items of the digital camera, at the time of reproducing recorded images.

FIG. 7C is a diagram illustrating an example of a “monotone display” in the event of selecting and okaying “single frame display” from the menu items of the digital camera, at the time of reproducing recorded images.

FIG. 8 is a block diagram illustrating a digital camera to which a second embodiment of the present invention is applied.

FIG. 9 is a diagram illustrating the configuration of a CCD image pickup device and driving circuit according to the second embodiment.

FIG. 10 is a program diagram illustrating the method for controlling exposure, according to the second embodiment.

FIG. 11 is a flowchart drawing illustrating the general procedures for controlling exposure, according to the second embodiment.

FIG. 12 is a time chart illustrating the operations of exposure control.

FIG. 13 is a time chart illustrating the operations of exposure control.

FIG. 14 is a time chart illustrating the operations of exposure control.

FIG. 15 is a time chart illustrating the operations of exposure control.

FIG. 16 is a time chart example of image format conversion processing performed by a digital camera according to a third embodiment of the present invention.

FIG. 17 is a block diagram of a moving-image processing system which the digital camera according to the third embodiment comprises.

FIG. 18 is a flowchart illustrating an operational example of the control unit in a case wherein moving-image shooting is performed with the digital camera.

FIG. 19 is a flowchart illustrating an example of processing for selecting processing relating to moving-images.

FIG. 20 is a flowchart illustrating an operational example of the control unit in step S403 in FIG. 19.

FIG. 21 is a flowchart illustrating an operational example of the control unit in step S505 in FIG. 20.

FIG. 22 is a flowchart illustrating an operational example of the control unit in step S509 in FIG. 20.

FIG. 23 is a diagram illustrating an example of a mode displayed on the display unit.

FIG. 24 is a diagram illustrating an example of moving-image shooting conditions displayed on the display unit.

FIG. 25 is a diagram illustrating another example of moving-image shooting conditions displayed on the display unit.

FIG. 26 is a diagram illustrating another example of moving-image shooting conditions displayed on the display unit.

FIG. 27 is a diagram illustrating another example of moving-image shooting conditions displayed on the display unit.

FIG. 28 is a diagram illustrating another example of moving-image shooting conditions displayed on the display unit.

FIG. 29 is a diagram illustrating another example of combining multiple types of moving-image shooting conditions displayed on the display unit.

FIG. 30 is a flowchart illustrating a control example of the control unit at the time of shooting moving-images, including judgment for display/non-display of the moving-image shooting conditions while shooting the moving-images.

FIG. 31 is a diagram illustrating a display example of displaying the moving-image shooting conditions on the display screen while shooting the moving-images.

FIG. 32 is a flowchart illustrating a control example of the control unit at the time of shooting moving-images, including judgment for display/non-display of the moving-image shooting conditions during reproducing the moving-images.

FIG. 33 is a diagram illustrating a display example of displaying the moving-image shooting conditions on the display screen during reproducing the moving images.

### DESCRIPTION OF THE PREFERRED EMBODIMENTS

Description will be made regarding embodiments of the present invention with reference to the drawings.

First of all, description will be made regarding a first embodiment of the present invention.

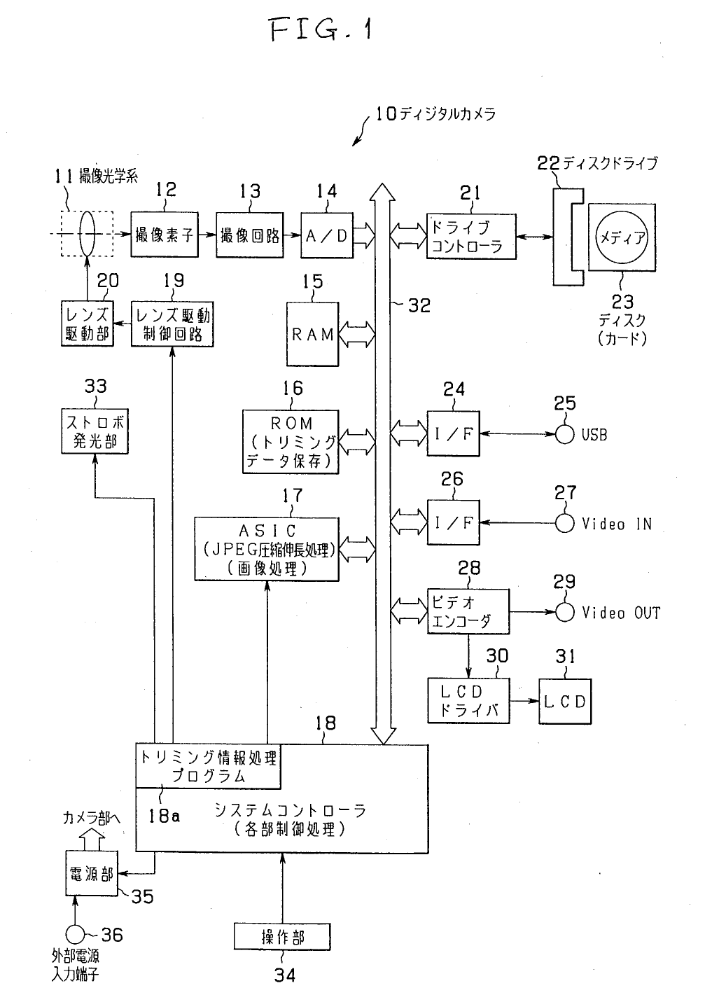

FIG. 1 illustrates a block diagram of a digital camera of the first embodiment according to the present invention. Note that the term “mask” and the term “trimming” will be used synonymously hereafter.

In FIG. 1, a digital camera 10 comprises an image pickup optical system 11, image pickup device 12, an image pickup circuit 13, an A/D converter 14, RAM 15 serving as frame buffer memory, ROM 16 for storing trimming data, an ASIC 17 configured as an IC for image processing, a system controller 18, a lens driving control circuit 19, a lens driving unit 20, a disk drive controller 21, a disk drive 22 configured as a card slot, a disk (or card) 23 serving as a recording medium, an interface (which will be referred to as I/F hereafter) 24 for performing transmission/reception of video signals to and from USB-compatible external devices, a USB input/output terminal 25, an interface (which will be referred to as I/F hereafter) 26 for inputting video signals from external video devices, a video input terminal 27, a video encoder 28 serving as a video outputting circuit, a video output terminal 29, an LCD driver 30, a liquid crystal panel (which will be referred to as LCD hereafter) 31 serving as electronic display unit, a data bus 32 for connecting between the system controller 18 and each digital circuit, a strobe emission unit 33, an operating unit 34, a power source unit 35, and an external power source input terminal 36. Note that, in the drawing, the disk (or card) 23 is detachably mounted on the camera 10.

The image pickup optical system 11, which is configured as a zoom lens system, for example, forms an image of the subject in an optical manner. The image pickup device 12 performs photoelectric conversion for images on the image pickup face of the subject subjected to image formation by the image pickup optical system 11 so as to generate and output electric imaging signals (analog signals) The image pickup circuit 13 controls the image pickup device 12, and also performs a processing necessary for analog signals output from the image pickup device 12, whereby the analog signals are output. The A/D converter 14 converts analog signals output from the image pickup device 13 into digital signals. The RAM 15 temporarily stores the image data converted by the A/D converter 14. And, the RAM 15 temporarily stores the image data read out from the disk 23, or the trimming data read out from the ROM 16.

The ROM 16 stores various trimming forms as trimming data, which is one of features of the present invention.

The ASIC 17 for image processing performs various image processing for image data stored in the RAM 15 according to the control by the system controller 18 described later, and also performs JPEG compression in the event of recording the data on the disk 23, and performs JPEG expansion in the event of reading out from the disk 23 described later.

The lens driving control circuit 19 controls the lens driving unit 20 described later for performing zoom or auto-focus according to the control by the system controller 18. The lens driving unit 20 drives zoom lenses or focusing lenses included in the image pickup optical system 11 according to the control by the lens driving control circuit 19.

The drive controller 21 controls so as to record the image data subjected to JPEG compression by the ASIC 17 on the disk 23 described later, or so as to read out image data recorded on the disk 23, according to the control by the system controller 18.

The disk drive 22 is electrically connected to the disk 23 so as to transmit and receive signals to and from the drive controller 21. The disk 23 is a card-shaped nonvolatile recording medium which can be freely detachably connected to the disk drive 22.

The I/F 24 transmits and receives signals to and from USB-compatible external devices according to the control by the system controller 18. The input/output terminal 25 is connected to the USB-compatible external device through a connecting code or the like so as to transmit and receive signals to and from the I/F 24.

The I/F 26 inputs video signals from an external video device having a video output terminal according to the control by aforementioned system controller 18. The input terminal 27 is connected to the external video device through a connecting code or the like so as to input video signals (Video IN) to the I/F 26.

The video encoder 28 outputs LCD displaying images for each frame in the event that the operator determines the picture composition of the subject or the like, prior to image shooting, and outputs an LCD displaying image for one frame in the event of reproducing an image after image shooting, based upon the image data stored in the RAM 15. The video encoder 28 can also output video signals (Video OUT) to an unshown external video device connected to the video output terminal 29. The LCD driver 30 supplies LCD displaying images for each frame from the video encoder 28 to the LCD 31 along with display-driving clock signals.

The LCD 31 makes up a display unit wherein the output from the video encoder 28 is received, and images and information or the like with regard to the camera are displayed.

The strobe emission unit 33 emits illumination light in the event that the luminance of the subject is low, or the principal subject is against a backlight, according to the control by the system controller 18.

The operating unit 34 includes means for the user to operate a power source on/off unit, an exposure activating unit (which is also referred to as release unit or trigger unit), a frame advancing unit, and an image display on/off unit, and also includes means for performing selection and editing (described later) of the trimming form, which is one of features of the present invention.

The power source unit 35 supplies electric power to each unit within the camera 10. Furthermore, the external power source input terminal 36 supplies electric power to the power source unit 35 in the event that an unshown external power source is connected thereto.

The system controller 18 having each circuit described above centrally controls the entire camera 10, and in the event of taking images and recording according to the command from the operating unit 34, the system controller 18 performs display processing, controls the ASIC 17 or the like for performing recording processing or the like, and also performs control for reading out the image data recorded on the disk 23 within the camera 10, and displaying the image data. Furthermore, the system controller 18 has a trimming information processing program 18a, which is a feature of the present invention, for a trimming processing mode wherein one trimming form is selected, and then the selected trimming form is read out from the various trimming forms stored in the ROM 16 so as to display as LCD displaying data on the image data in image shooting in a superimposed manner, or trimming image data shot in the trimming processing mode is recorded on the disk 23 with the trimming image data having been separated into image data and trimming form identification signals.

The trimming information processing program 18a performs selection of a mask, mask displaying, adjustment of image quality, and recording and reproducing of the trimming information, according to the intentions (operations) of the user.

The image file taken by the digital camera has a tag configuration wherein a file name, date of taking the image, shooting conditions such as diaphragm, shutter speed, and the like have been written within the tag in image recording.

The trimming information processing program 18a writes the “mask No.” selected by the user to the tag in the same way as the aforementioned information. Or, an arrangement may be made wherein the mask No. is separately recorded corresponding to the file name or the date of image shooting (without writing the mask No. to the tag). The mask No. should be recorded with the mask corresponding to the image. The user can see the tag information with regard to the image file (e.g., the date of image shooting for the image) using application software or the like.

Also, the aforementioned operating unit 34 comprises not only the power source switch, frame advancing switch, and display on/off switch, but also a release button for performing image shooting operations, a menu button for displaying on the image display LCD 31 a menu with regard to the settings and the like for the camera 10, a cross-shaped button for moving selectable items in the displayed menu, a check button (OK button) for okaying the selected item, and furthermore, a mask button or the like for performing trimming for the taken image in image shooting, which is one of features of the present invention.

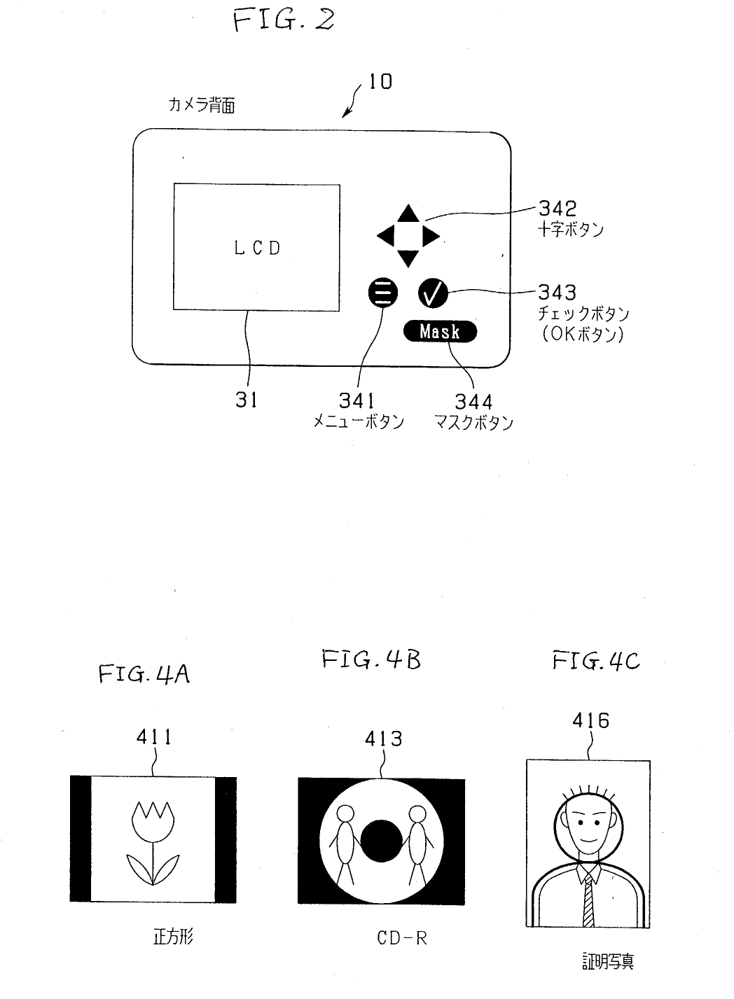

FIG. 2 illustrates a rear view of the above-described digital camera 10. The digital camera 10 has a display screen of the LCD 31 on the backside, and near the display screen of the LCD 31 has a menu button 341 for displaying a menu screen, a cross-shaped button 342 for moving a cursor in the vertical and horizontal directions on the menu screen so as to select a desired item from the menu screen, a check button (OK button) 343 for okaying the selected item and placing a check mark, and a mask button 344 for superimposing the selected mask pattern (trimming form) on the taken image after selecting a shooting mask from the menu screen.

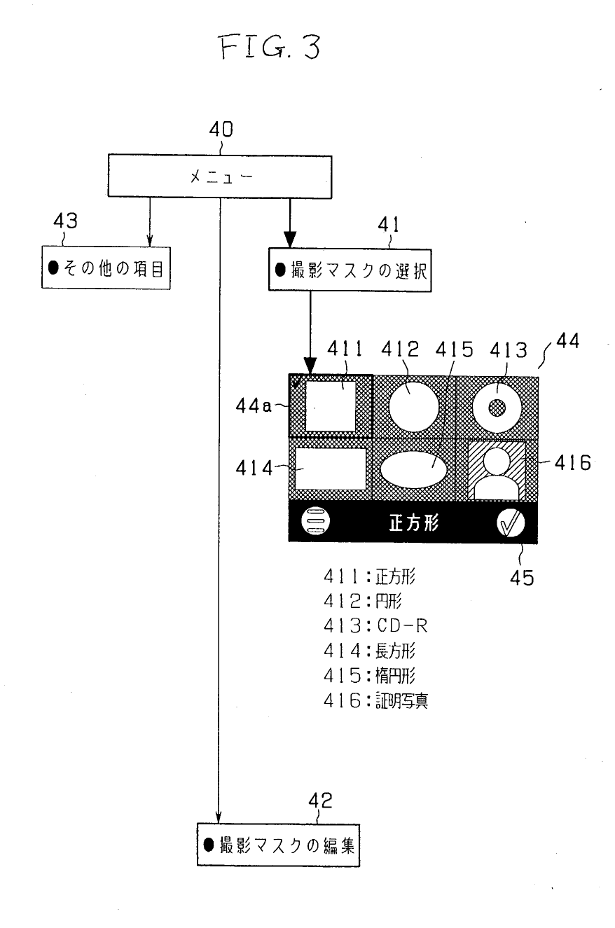

Next, description will be made regarding the functions and the operations of the features of the present invention with regard to the digital camera having the above-described configuration with reference to FIG. 3 through FIG. 7.

FIG. 3 illustrates a feature according to the present invention, of the menu items which is displayed upon the menu button 341 shown in FIG. 2 being pressed.

An item “selection of shooting mask” 41 and an item “editing of shooting mask” 42, according to the present invention, are provided to the items for a menu 40 displayed on the menu screen. It is needless to say that other various selectable items 43 are also provided.

First of all, upon selecting the menu item “selection of shooting mask” 41 with the cross-shaped button 342, and determining with the check button 343, the following are displayed on the screen of the LCD 31: a list display for multiple (six in the drawing) shooting masks 44 as trimming forms, a frame display 44a serving as a movable cursor for selecting one of the shooting masks, and a bar display 45 (which is illustrated in black in the drawing) including a display of the presently-selected trimming form name and a mark display of the selectable operating button.

Multiple trimming forms (mask forms) such as a square 411, a circle 412, a doughnut-shaped CD-R (CD-Recordable, CD wherein data can be written to the same region only one time) 413, a rectangle 414, an ellipse 415, and a photograph for certificate 416, for example, are displayed on the list display for shooting masks 44.

In the event of selecting the square 411 as a trimming form in image shooting as shown in FIG. 3, upon moving and setting the frame display 44a serving as a cursor to the square 411 with the cross-shaped button 342, and pressing the check button 343 for selecting the square 411 on which the frame display 44a is placed, a check mark is displayed at the upper left corner of the square 411 on which the frame display 44a is placed.

Next, in a case of shooting images actually with the aforementioned selected shooting mask (e.g., square), upon training the shooting lens on the subject (e.g., flower) with the square shown in FIG. 3 being selected and the mask button 344 shown in FIG. 2 being pressed, a subject image on which the above-described mask has been superimposed is displayed on the screen of the LCD 31. That is to say, image shooting can be performed with the subject image being positioned at a desired position within the region restricted (subjected to trimming) by the square 411 as shown in FIG. 4A.

Note that upon pressing the mask button 344, the image on which the mask has been superimposed is displayed on the LCD screen only while pressing the mask button 344, and upon releasing the mask button 344, a normal image without the mask is displayed. Or, the trimming information processing program 18a for the system controller 18 may be made such that upon pressing the mask button 344 one time, the image on which the mask has been superimposed is displayed on the LCD screen, and upon pressing the mask button 344 again, the normal image without mask is displayed.

FIG. 4A through FIG. 4C illustrate LCD display examples wherein FIG. 4A, FIG. 4B, and FIG. 4C illustrate examples of shooting masks (i.e., trimming forms) of the square, CD-R, and photograph for certificate, respectively.

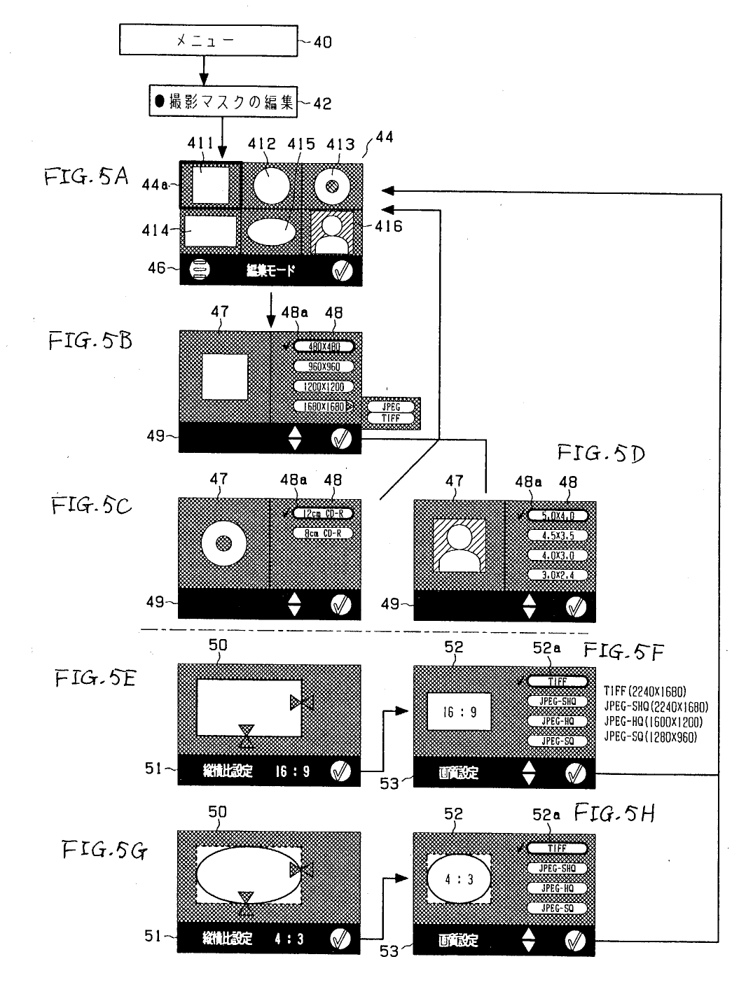

In FIG. 5A, upon selecting the item “editing of the shooting mask” 42 from the items on the menu screen displayed in FIG. 3 with the cross-shaped button 342 and determining with the check button 343, the following are displayed on the screen of the LCD 31: the list display for multiple (six in the drawing) shooting masks 44 as trimming forms, the frame display 44a serving as a movable cursor for selecting one of the shooting masks, and a bar display 46 (which is illustrated in black in the drawing) including a display indicating the present state being in the edit mode and a mark display of the selectable operating button.

Now, in the event that the list display 44 shown in FIG. 5A is displayed with the frame display 44a serving as a cursor being set to the square 411, for example, among the trimming forms, upon pressing the check button 343, transition is made to the single frame display state wherein the mask form of the square 411 shown in FIG. 5B is displayed. The screen following transition is a screen wherein the above-described list display 44 is divided into two regions where the left side is a screen 47 for displaying the mask form, and the right side is a screen 48 having choices from which the operator can change and set the number of pixels (the number of pixels is synonymous with the size or resolution) of the image displayed on the region of the square 411. Reference character 48a denotes a frame display serving as a cursor for selection, and a check mark shown on the left side indicates that selection has been made with the check button 343. Furthermore, in FIG. 5B, the above-described bar display 46 becomes a bar display 49 including only a mark display as selectable buttons (marks of an up-and-down key of the cross-shaped button 342 and the check button 343). The screen 48 for changing and setting the number of pixels has the four choices of number of pixels of 480×480, 960×960, 1200×1200, and 1680×1680, and furthermore, has choices of JPEG and TIFF for the number of pixels 1680×1680. In the drawing, a state is displayed wherein the cross-shaped button 342 is operated so as to set the cursor to the number of pixels 480×480 following which the check button 343 is pressed so as to select the number of pixels 480×480 with a check mark being placed thereupon. In the state shown in FIG. 5B, upon pressing the mask button 344, the image on which the mask in a square shape has been superimposed is displayed, and upon shooting an image in this state, an image is recorded with the number of pixels of 640×480. The image is subjected to trimming, whereby an image with a number of pixels of 480×480 is formed.

In the same way, in FIG. 5A, upon pressing the check button 343 following selection of the CD-R 413, transition is made to the single frame display state which displays the mask form of the CD-R 413 shown in FIG. 5C. At this time, the CD-R with a diameter of 12 cm or the CD-R with a diameter of 8 cm can be selected from the screen 48 displaying the choices. In FIG. 5C, the state is shown wherein the CD-R with a diameter of 12 cm is selected, and determination is made with the check button 343.

Also, in the same way, in FIG. 5A, upon pressing the check button 343 following selection of the photograph for certificate 416, transition is made to the single frame display state which displays the mask form of the photograph for certificate 416 shown in FIG. 5D. At that time, the screen 48 for displaying choices has the four choices of size of the photograph image (which is corresponding to the unit of cm or the number of the pixels) of 5.0×4.0, 4.5×3.5, 4.0×3.0, and 3.0×2.4. FIG. 5D illustrates the state wherein the image size of 5.0×4.0 is selected and then a determination is made with the check button 343.

The forms of the square, CD-R, and photograph of certificate are each predetermined, and the operator can edit the forms to the extent of altering the number of pixels. Note that the operator can edit the form to the extent of altering the number of pixels in the case of a circle as well, though not particularly shown in the drawings.

On the other hand, in a case of the mask form (trimming form) being the rectangle or ellipse, the operator can edit not only the number of pixels but also the aspect ratio.

FIG. 5E illustrates an edit screen which is displayed upon selecting the rectangle shown in FIG. 5A and pressing the check button 343. The edit screen is a screen which has been divided into two regions, and is formed of a screen 50 displaying a single frame display for displaying the mask form of the rectangle 414 and a screen 51 for displaying a bar placed underneath the screen 50. On the screen 50, triangle displays in the similar shape to the cross-shaped button are displayed such that each of the vertical and horizontal sides of the rectangle is placed therebetween, and the operator operates the cross-shaped button 342 so as to change the aspect ratio of the rectangle. Furthermore, on the screen 51 for displaying the bar, the operable check button 343 is displayed while the aspect ratio (16:9 in the drawing) computed by the system controller 18 in the process in which the aspect ratio of the rectangle is changed in the screen 50 is displayed.

Following determination of the aspect ratio in FIG. 5E, upon pressing the check button 343, transition is made to the screen shown in FIG. 5F. The screen following transition has been divided to two regions, and is formed of a screen 52 which displays the choices for selecting the image quality (number of pixels) in addition to displaying the aspect ratio determined in FIG. 5E, and a screen 53 which displays a bar display for displaying a display “image quality setting”, and an operable cross-shaped button and check button disposed underneath the screen 52. In FIG. 5F, a frame display 52a serving as a cursor which can be moved by the cross-shaped button 342 is displayed, the item “TIFF” is selected as image quality, and a check mark following operating the check button 343 is displayed. In the state shown in FIG. 5F, upon operating the mask button 344, the shooting image subjected to trimming (masking) in a rectangular shape is displayed on the LCD 31.

Subsequently, upon the operator pressing an unshown release button (shutter button) of the camera 10 while watching the LCD image, the shot image signals are recorded on the disk 23 along with the trimming form identification signals as mask information, and at the same time, the shot image on which the mask is superimposed is displayed on the LCD.

Note that TIFF indicates a non-compression format, which has a number of pixels of 2240×1680, for example, and JPEG-SHQ indicates a format with a low compression ratio and high image quality, which has a number of pixels of 2240×1680, for example. JPEG-HQ indicates a format with a normal compression ratio, which has a number of pixels of 1600×1200, for example, and JPEG-SQ indicates a format with a low compression ratio, which has a number of pixels of 1280×960, for example.

FIG. 5G illustrates an edit screen which is displayed upon selecting the ellipse shown in FIG. 5A and pressing the check button 343. The edit screen is a screen which has been divided into two regions in the same way as in FIG. 5E, and formed of the screen 50 which displays a single frame display image for displaying the mask form of the ellipse 415, and the screen 51 for displaying a bar display placed underneath the screen 50. On the screen 50, triangle displays in the similar shape to the cross-shaped button are displayed such that each of vertical and horizontal portions of the ellipse is placed therebetween, and the operator operates the cross-shaped button 342 so as to change the aspect ratio of the ellipse. Furthermore, on the screen 51 for displaying the bar, the operable check button 343 is displayed while the aspect ratio (4:3 in the drawing) computed by the system controller 18 in the process in which the aspect ratio of the ellipse is changed in the screen 50 is displayed.

Upon pressing the check button 343, transition is made to a screen shown in FIG. 5H. The screen following transition has been divided into two regions in the same way as in FIG. 5F, the aspect ratio determined in FIG. 5G is displayed, and also is formed of the screen 52 which displays the choices (as with in FIG. 5F) for setting the image quality (number of pixels), and the screen 53 which displays a bar display for displaying the item “image quality selection” and the operable cross-shaped button and check button disposed underneath the screen 52. In FIG. 5H, the item “TIFF” is selected as image quality, and a check mark after the operation of the check button 343 is displayed. In the state in FIG. 5H, upon operating the mask button 344, the image subjected to trimming (masking) in an elliptic shape is displayed on the LCD 31.

Subsequently, upon the operator pressing an unshown release button (shutter button) of the camera 10 while watching the LCD image, shot image signals are recorded on the disk 23 along with trimming form identification signals as mask information, and at the same time, the shot image on which the mask is superimposed is displayed on the LCD.

In order to reproduce the shot image recorded on the disk 23, the operator presses the menu button 341 so as to display the menu screen, and upon the operator selecting the item “dividing display” or “single frame display” from the menu, and pressing the check button 343 for determination. The “dividing display” is a format wherein the multiple images recorded on the disk 23 are displayed in a divided-screen manner so as to display a list of the multiple images, and “single frame display” is a format wherein one frame of the multiple images recorded on the disk 23 is sequentially displayed while advancing frames. Note that, with the “single frame display”, the operator displays the next frame using the right-and-left key of the cross-shaped button 342.

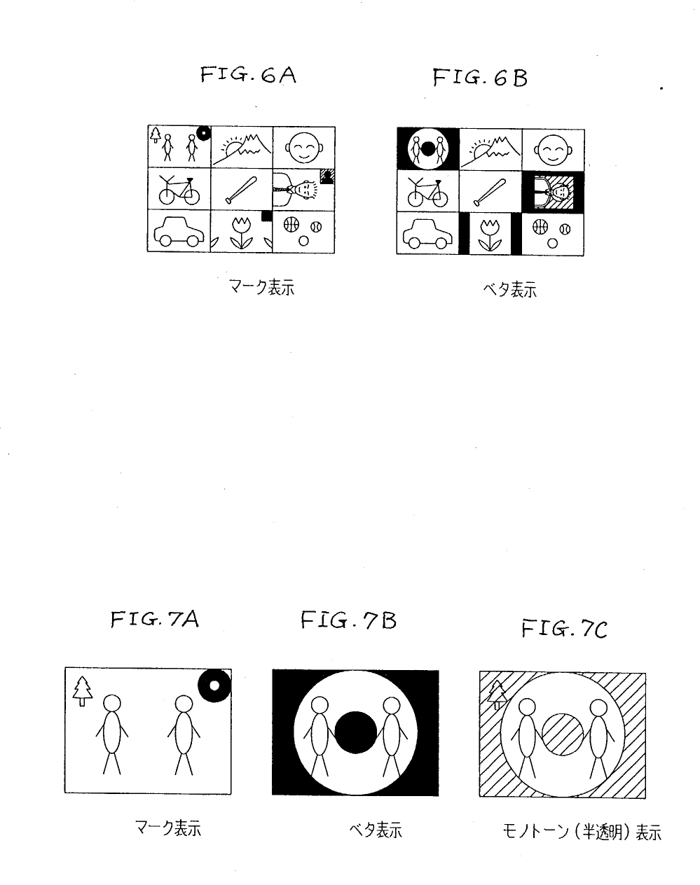

FIG. 6A and FIG. 6B illustrate dividing display examples in the event that the item “dividing display” is selected from the menu items and okayed.

FIG. 6A illustrates an example wherein dividing display is made for the images shot with and without masking, i.e., a mask form (trimming form) is added to each image shot with masking at the upper right corner, upon reproducing. FIG. 6B is an arrangement wherein dividing display is made for the images shot with and without masking, i.e., a mask is superimposed on each image shot with masking, upon reproducing. Note that, in the event that the operator selects the item “dividing display” from the menu items and okays the determination, either screens shown in FIG. 6A or in FIG. 6B may be displayed, or a configuration may be made wherein in the event that the operator selects the item “dividing display” and okays the determination, the items “mark display” and “solid display” are displayed as sub-menu items so that the operator can arbitrary select either screens shown in FIG. 6A or FIG. 6B.

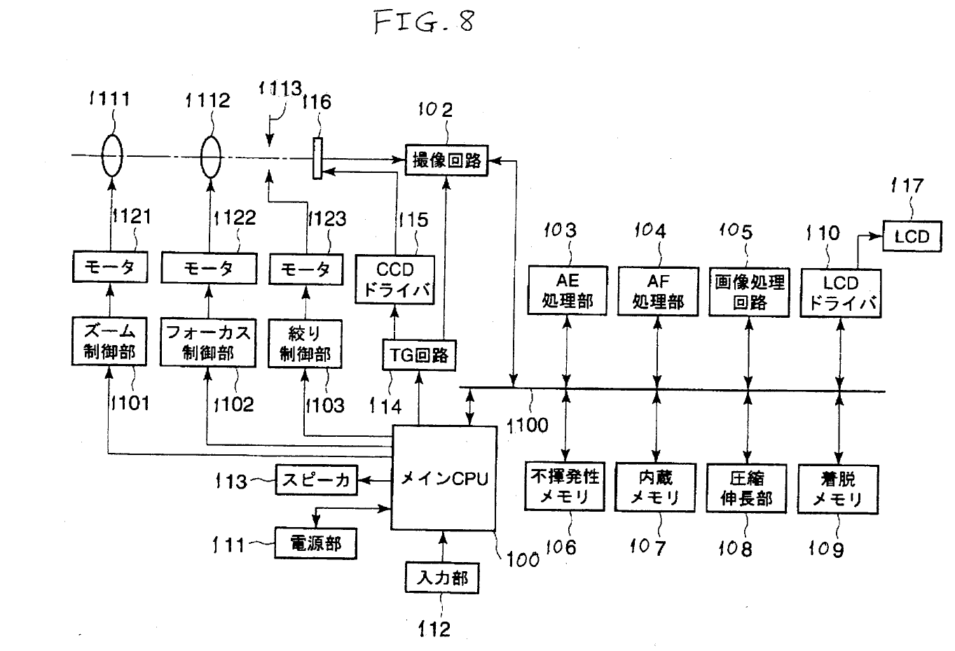

FIG. 7A through FIG. 7C illustrate single frame display examples in a case that the operator selects the item “single frame display” from the menu and okays the determination.

FIG. 7A illustrates an example wherein an image which has been shot with masking is displayed with a mask form being added to the image at the upper right corner when reproducing images which have been taken with or without masking. FIG. 7B illustrates an example wherein an image which has been shot with masking is reproduced and displayed with a mask in black solid display being superimposed on the image. FIG. 7C illustrates an example wherein an image which has been shot with masking is reproduced and displayed with a mask in monotone (translucent) display being superimposed on the image. Note that an arrangement may be made wherein an image which has been shot with masking is reproduced and displayed with a mask in suitable color display (e.g., blue) being superimposed on the image. Note that, in the event that the operator selects the item “single frame display” and okays the determination, one of the screens shown in FIG. 7A, FIG. 7E, and FIG. 7C, may be displayed, or an configuration may be made wherein in the event that operator selects the item “single frame display” and okays the determination, the items “mark display”, “solid display”, and “monotone display” are displayed as the submenu items so that the operator can arbitrarily select one of the displays shown in FIG. 7A, FIG. 7B, and FIG. 7C.

Another arrangement besides the above-described arrangements may be made wherein a switching button is provided on the side face or the like of the main body of the digital camera 10 so as to prevent malfunctioning of the mask button 344, and as long as the switching button is not pressed (off state), the mask button 344 does not effectively function, and in the event that the switching button is pressed (turned on), the mask button becomes effective, and in this state, upon pressing the mask button 344 so as to enter the trimming mode, the screen having the mask list display 44 as shown in FIG. 3 is directly displayed on the LCD 31, and the operator can select a desired mask from the list, and upon pressing the mask button 344 when shooting images, a shot image on which the mask is superimposed is displayed on the LCD.

A series of the operations for trimming processing (mask processing) according to the embodiment as described above can be performed with the control processing by the system controller 18.

That is to say, the digital camera 10 comprises an image pickup optical system for forming an image of the subject, and an image pickup device for generating image signals corresponding to the light cast onto the image pickup face of the image pickup device by the image pickup optical system, and can display the shot image on the LCD 31 under the control of the system controller 18, and can perform JPEG compression processing for the shot image in the image processing ASIC 17 and record the image on the disk 23 under the control of the system controller 18, and conversely, the digital camera 10 can read out the image recorded on the disk 23, perform JPEG expansion processing for the image in the image processing ASIC 17, and display the image on the LCD 31, under the control of the system controller 18.

The system controller 18 stores the trimming information processing program 18a for performing trimming processing (mask processing), reads out desired trimming data from the various trimming forms stored in the ROM 16 according to the command from the operating unit 34, and performs control processing such as processing wherein the shot image is displayed with LCD with the mask from the read out trimming data being superimposed thereupon, and processing wherein the read out trimming data is recorded on the disk 23 in a correlated manner with the shot image. Furthermore, the image which has been shot with a mask is subjected to control processing wherein the image is reproduced as an image with the mask when reproducing the image recorded on the disk 23.

Accordingly, the system controller 18 has means necessary for performing the above-described control processing, as described below.

That is to say, the system controller 18 comprises: a trimming form selecting unit for selectively setting the trimming form suitable for the purpose of use of the image recorded; a first signal processing unit for performing signal processing for the output from the image pickup device 12 such that the image can be observed with a format according to the trimming form selectively set by the trimming form selecting unit, and for supplying the image to the LCD 23 which is applied as an electronic display unit; a second signal processing unit for obtaining, based upon the output from the image pickup device 12, the signals to be recorded that are suitable for being recorded on the disk 23, which is a recording medium, with partial image loss not occurring due to trimming in the first signal processing unit, and which is accompanied by trimming form identification signals indicating the trimming form with regard to the image which has been selectively set by the aforementioned trimming form selecting unit; a recording operation activation unit for recording the image signals subjected to processing by the aforementioned second signal processing unit on the disk 23 as an applied recording medium, in responding to the operations to a trigger unit such as a release button (not shown); and an image reproducing unit for reproducing the image signals recorded on the aforementioned disk 23 with a form corresponding to the trimming form indicated by the trimming form identification signals accompanying the image signals.

Furthermore, the system controller 18 further includes a mode switching unit for effectively functioning the aforementioned first signal processing unit. The mode switching unit functions according to the mask button 344.

The trimming selecting unit comprises a trimming data storage unit such as the ROM 16 for storing various types of trimming data so that the aforementioned first signal processing unit performs trimming processing corresponding to the multiple trimming forms which have been set beforehand, and a selecting operating unit for selecting a specified form from the multiple trimming data corresponding to the trimming data stored in the trimming data storage unit.

The first signal processing unit is configured such that the output from the image pickup device 12 is subjected to processing wherein the image data on the region to be removed with the trimming is replaced with mute signals, or processing substantially the same as the aforementioned processing, with a form according to the trimming form selectively set by the aforementioned trimming form selecting unit.

Also, the first signal processing unit may be configured such that the operating mode wherein the signal processing unit performs signal processing in which an image is observed with a form according to the trimming form which has been selectively set by the aforementioned trimming form selecting unit (an image subjected to trimming is observed), and the operating mode wherein the signals are passed through without being subjected to performing of the aforementioned processing (the image in the normal state is observed), can be switched over.

More specifically, the first signal processing unit comprises: a first signal transmission path (path for performing trimming) for performing signal processing for the output from the image pickup device 12 such that an image is observed with a form according to the trimming form selectively set by the aforementioned trimming form selecting unit; a second signal transmission path (path for by-passing trimming) for supplying signals from the output of the image-pickup device 12, which has not been subjected to the aforementioned signal processing, to the aforementioned LCD 31; and a trimming/normal switching unit for switching the aforementioned first signal transmission path and the aforementioned second signal transmission path so as to apply one of the paths at an arbitrary timing by the operator. Here, each control processing for the aforementioned first signal transmission path, second signal transmission path, and trimming/normal switching unit, is a function which is performed by the system controller 18 by software and conceptually exists in the system controller 18.

With the trimming/normal switching unit, in the event that the operator performs operations for a predetermined operating unit (e.g., mouse button 344), the aforementioned first signal transmission path is applied (i.e., an image with trimming is observed), and in the event that the operator does not perform operations for the predetermined operating unit, the aforementioned second signal transmission path is applied (i.e., an image in the normal state is observed).

The trimming form selecting unit further comprises a trimming menu display unit to display as one menu screen for arranging and displaying a predetermined number of trimming forms of the multiple trimming forms corresponding to the trimming data stored in the aforementioned trimming data storage unit on the LCD 31 which is applied as an electronic display unit, and the aforementioned trimming form selecting unit is configured such that the operator can arbitrarily select a trimming form from the trimming forms displayed on the LCD 31 by the trimming menu displaying unit. That is to say, an arrangement may be made wherein a trimming form is selected from the menu screen.

An arrangement may be made wherein the aforementioned trimming form selecting unit further comprises a manual trimming unit for selectively setting a trimming form so as to generate corresponding trimming data according to predetermined operations by the operator in addition to the multiple trimming forms corresponding to the trimming data stored in the aforementioned trimming data storage unit beforehand. That is to say, with the arrangement, the operator can arbitrarily make a trimming pattern in addition to the trimming patterns prepared beforehand.

The trimming/normal switching unit has a configuration wherein the first signal transmission path and second signal transmission path are switched at an arbitrary timing by the operator according to the switching operations performed for a certain switching switch. An arrangement may be made wherein, with the aforementioned trimming/normal switching unit, in the event that the operator performs operations for a predetermined operating unit (e.g., mask button 344), the aforementioned first signal transmission path is applied (an image with trimming is observed), and in the event that the operator performs the same operations for the aforementioned operating unit again, the aforementioned second signal transmission path is applied (an image is observed in the normal state). The first and second signal transmission paths may be conceptually configured.

The trimming/normal switching unit may have a configuration wherein the aforementioned first signal transmission path and second signal transmission path are switched at an arbitrary timing by the operator according to the amount of operation (e.g., full stroke or half stroke) performed for an operating unit which is also served as a trigger unit (e.g., release button). For example, an arrangement may be made wherein the first and second transmission paths are switched according to the operation of the release button being full-stroke or half-stroke.

The image reproducing unit is configured such that a pattern indicating the trimming form set by the aforementioned trimming form selecting unit is placed at a peripheral position relatively far from the center portion of the image so that partial loss is not generally caused for the image with trimming. That is to say, the image with trimming is generally entirely displayed on one region of the screen, and the trimming form is displayed at the upper right portion on the image in a symbolic manner.

The aforementioned image reproducing unit may be configured such that a reproduced image is displayed with the image subjected to trimming set by the aforementioned trimming form selecting unit. That is to say, with the arrangement, an image is reproduced and displayed with the exact form as subjected to trimming.

An arrangement may be made wherein the camera further comprises a shooting conditions automatic setting unit for automatically performing setting for the shooting conditions. That is to say, setting for the camera is automatically performed corresponding to the trimming form which has been selectively set by the aforementioned trimming form selecting unit.

The shooting conditions automatic setting unit may be configured such that settings for shooting conditions including settings for the number of pixels making up a recorded image are automatically performed corresponding to the trimming form which has been selectively set by the aforementioned trimming form selecting unit.

The shooting conditions automatic setting unit may be configured such that settings for shooting conditions including settings for the information-compression ratio with regard to a recorded image are automatically performed corresponding to the trimming form which has been selectively set by the aforementioned trimming form selecting unit.

The shooting conditions automatic setting unit may be configured such that settings for shooting conditions including settings for the resolution with regard to a recorded image are automatically performed corresponding to the trimming form which has been selectively set by the aforementioned trimming form selecting unit.

The shooting conditions automatic setting unit may be configured such that settings for shooting conditions including settings for the color tone with regard to a recorded image are automatically performed corresponding to the trimming form which has been selectively set by the aforementioned trimming form selecting unit.

The shooting conditions automatic setting unit may be configured such that settings for shooting conditions including settings for the size of the image are automatically performed corresponding to the trimming form which has been selectively set by the aforementioned trimming form selecting unit.

The shooting conditions automatic setting unit may be configured such that settings for shooting conditions including settings for the diaphragm are automatically performed corresponding to the trimming form which has been selectively set by the aforementioned trimming form selecting unit.

The shooting conditions automatic setting unit may be configured such that settings for shooting conditions including settings for the depth of field are automatically performed corresponding to the trimming form which has been selectively set by the aforementioned trimming form selecting unit.

The shooting conditions automatic setting unit may be configured such that settings for shooting conditions including settings for the photometry method are automatically performed corresponding to the trimming form which has been selectively set by the aforementioned trimming form selecting unit.

The shooting conditions automatic setting unit may be configured such that settings for shooting conditions including settings for on/off of the flash are automatically performed corresponding to the trimming form which has been selectively set by the aforementioned trimming form selecting unit.

The shooting conditions automatic setting unit may be configured such that setting for shooting conditions including settings for flash so as to reduce red-eye are automatically performed corresponding to the trimming form which has been selectively set by the aforementioned trimming form selecting unit.

The shooting conditions automatic setting unit may be configured such that settings for shooting conditions including settings for the contrast with regard to a recorded image are automatically performed corresponding to the trimming form which has been selectively set by the aforementioned trimming form selecting unit.

The shooting conditions automatic setting unit may be configured such that settings for shooting conditions including settings for the sharpness with regard to a recorded image are automatically performed corresponding to the trimming form which has been selectively set by the aforementioned trimming form selecting unit.

The shooting conditions automatic setting unit may be configured such that settings for shooting conditions including settings for the gamma correction with regard to a recorded image are automatically performed corresponding to the trimming form which has been selectively set by the aforementioned trimming form selecting unit.

The shooting conditions automatic setting unit may be configured such that settings for shooting conditions including settings for the brightness with regard to a recorded image are automatically performed corresponding to the trimming form which has been selectively set by the aforementioned trimming form selecting unit.

The shooting conditions automatic setting unit may be configured such that settings for shooting conditions including settings for the edge portions with regard to a recorded image are automatically performed corresponding to the trimming form which has been selectively set by the aforementioned trimming form selecting unit.

The shooting conditions automatic setting unit may be configured such that settings for shooting conditions including settings for the shutter speed are automatically performed corresponding to the trimming form which has been selectively set by the aforementioned trimming form selecting unit.

The shooting conditions automatic setting unit may be configured such that settings for shooting conditions including settings for the EV value are automatically performed corresponding to the trimming form which has been selectively set by the aforementioned trimming form selecting unit.

The shooting conditions automatic setting unit may be configured such that settings for shooting conditions including settings for the white balance are automatically performed corresponding to the trimming form which has been selectively set by the aforementioned trimming form selecting unit.

The shooting conditions automatic setting unit may be configured such that settings for shooting conditions including settings for the ISO sensitivity are automatically performed corresponding to the trimming form which has been selectively set by the aforementioned trimming form selecting unit.

The shooting conditions automatic setting unit may be configured such that settings for shooting conditions including settings for the zoom magnification are automatically performed corresponding to the trimming form which has been selectively set by the aforementioned trimming form selecting unit.

The shooting conditions automatic setting unit may be configured such that settings for shooting conditions including settings for the quantity of flash emission are automatically performed corresponding to the trimming form which has been selectively set by the aforementioned trimming form selecting unit.

The shooting conditions automatic setting unit may be configured such that settings for shooting conditions including settings for bracket image shooting are automatically performed corresponding to the trimming form which has been selectively set by the aforementioned trimming form selecting unit.

The shooting conditions automatic setting unit may be configured such that settings for shooting conditions including settings for the serial image shooting are automatically performed corresponding to the trimming form which has been selectively set by the aforementioned trimming form selecting unit.

The shooting conditions automatic setting unit may be configured such that settings for shooting conditions including settings for the data format for image recording are automatically performed corresponding to the trimming form which has been selectively set by the aforementioned trimming form selecting unit.

The shooting conditions automatic setting unit may be configured such that settings for shooting conditions including settings for the DPOF (Digital Print Oder Format: format for print information with regard to the digital camera) are automatically performed corresponding to the trimming form which has been selectively set by the aforementioned trimming form selecting unit. Note that DPOF is a format wherein information with regard to the specified images to be printed and the number of the specified images, selected from the images shot with the digital camera, information with regard to the specified images to be automatically transmitted and the addresses for transmission, information with regard to the specified images to be automatically reproduced, and the like, are recorded on a recording medium such as a memory card or the like, on which the image files are recorded, along with the images.

An arrangement may be made wherein a switching unit is further provided for selecting a automatic mode for automatically setting the settings with regard to the above-described shooting conditions or a manual mode for arbitrarily setting the settings such that the above-descried shooting conditions automatic setting unit functions in the event that the aforementioned automatic mode is selected by the aforementioned switching unit.

The trimming data storage unit of the aforementioned trimming form selecting unit may be configured such that the region of the image to be selectively removed with trimming is replaced by a mute image in a black level, gray level, or color level as one of the various types of trimming data.

The trimming data storage unit of the aforementioned trimming form selecting unit may be configured such that the region of the image to be selectively removed with trimming is replaced by an image wherein the base image is subjected to translucent masking as one of the various types of trimming data.

With the first embodiment according to the present invention as described with reference to FIG. 1 through FIG. 7, in the event that the shot image is to be used with the image subjected to trimming following image shooting, the operator can shoot an image of the subject in shooting conditions suitable for a desired trimming form selected from the trimming forms prepared beforehand, and desired trimming image shooting can be performed without such a trouble that the image of the subject gets out of the trimming frame. That is to say, image shooting suitable for desired trimming can be realized with easy operations simply by determining the camera angle.

Next, description will be made regarding a second embodiment of the present invention.

FIG.-8 is a block diagram which illustrates a configuration of the digital camera as an image pickup device to which the second embodiment of the present invention is applied.

The present digital camera comprises a lens group made up of a zoom lens 1111 and focus lens 1112, an iris structure 1113 for adjusting exposure, a CCD image pickup device 116 for converting an image of the subject into electric signals, an image pickup circuit 102 for converting the signals from the CCD image pickup device 116 into digital signals, an AE processing unit 103, connected to a signal bus 1100, for performing various processing for the digitized imaging signals, an AF processing unit 104, an image processing circuit 105, nonvolatile memory 106, built-in memory 107, a compression/expansion unit 108, detachable memory 109, and an LCD driver 110.

Furthermore, the present digital camera comprises a main CPU 100 for centrally controlling each unit, an input unit 112 made up of various types of switches, an LCD 117 for displaying the operating state and the mode state, a zoom control unit 1101 for controlling and driving lenses, a focus control unit 1102, motors 1121 and 1122, an iris control unit 1103 for controlling an iris 1113, a motor 1123, a timing generating circuit (which will be referred to as TG circuit hereafter) 114 for controlling a CCD driver 115, a CCD driver 15, a speaker 113 for outputting warning or the like, and a power source unit 111.

With the present digital camera, the main CPU 100 centrally performs entire control, and particularly, performs a series of processing with regard to exposure control, readout of signals from the CCD image pickup device 116 according to the driving control, and image processing.

Next, description will be made regarding operations of the present digital camera.

Various types of operating switches such as a zoom lever, release SW, power switch, and the like, are provided on the input unit 112. Now, upon the operator operating the release SW so as to be pressed one step, AE and AF operations are performed.

With the AE operations, image signals are acquired from the image pickup circuit 102, and transmitted to the AE processing unit 103. The AE processing unit 103 calculates the AE evaluation value wherein image signals in the predetermined region have been integrated, and transmits the value to the main CPU 100.

In the event that the AE evaluation value is compared with the internal standard value, and a determination is made that the luminance of the image of the subject is low, for example, the main CPU 100 instructs on the operations wherein the amplification factor of the image pickup circuit 2 is increased through the TG circuit 114, or the operations wherein the iris 1113 is opened through the iris control unit 1103. As described above, suitable exposure control is performed.

Next, the AF operations are performed. The image signals from the image pickup circuit 102 is input to the AF processing unit 4, and the AF processing unit 104 extracts high-frequency components from the image signals using filtering processing. Subsequently, the AF evaluation value or the contrast value wherein the high-frequency components have been integrated is calculated, and the value is transmitted to the main CPU 100. The main CPU 100 controls the focus control unit 1102 for driving of the motor 1122 such that the AF evaluation value exhibits the maximal value. As described above, focusing control is performed.

Upon the operator pressing the release SW up to the two steps, normal image-shooting operations are started.

The image of the subject is formed on the image pickup device 116 through the zoom lens 1111, the focus lens 1112, and the iris 1113. The imaging signals generated by the image pickup device 116 are input to the image pickup circuit 102, and are subjected to processing such as CDS (correlation double sampling), signal amplification, and the like, following which the signals are converted into digital signals, and are output to the signal bus 1100.

The AE processing unit 103, the AF processing unit 104, the image processing circuit 105, the nonvolatile memory 106, the built-in memory 107, the compression/expansion unit 108, the detachable memory 109, the LCD driver 110, and the like, are connected to the signal bus 1100.

The image data from the image pickup circuit 102 is temporarily stored in the built-in memory 107 following which the image data is subjected to processing such as processing of Y/C, processing of color matrix, and the like, in the image processing circuit 5. Subsequently, the image data is subjected to image compression in the compression/expansion unit 108, and is stored in the detachable memory 109. On the other hand, the image data from the image pickup circuit 102 is input to the LCD driver 110 as video signals, and is displayed on the LCD 117 as a through-image.

Also, in the event that the operator performs reproducing operations for images, the image data stored in the detachable memory 109 are read out, and following expansion processing by the compression/expansion unit 108, the image data is converted into an image with a required size in the image processing circuit 105, and the image is input to the LCD driver 110 so as to be displayed on the LCD 117.

Note that the nonvolatile memory 106 stores various types of programs and setting values for performing various types of processing as described above.

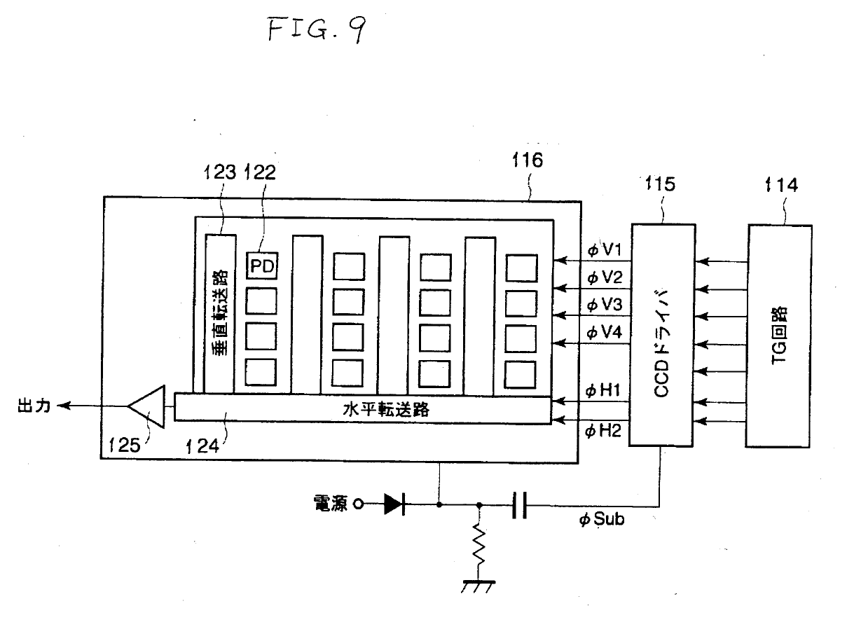

FIG. 9 is a diagram which illustrates a configuration of the CCD image pickup device 116 and the driving circuit according to the second embodiment.

The CCD image pickup device 116 comprises photo-sensors 122 disposed in a matrix manner within the image pickup area, a vertical transmission path 123, a horizontal transmission path 124, and an output amplifier 125.

The vertical transmission path 123 is provided corresponding to the vertical row of each photo-sensor 122, and is a register for reading out the accumulated charges from each photo-sensor 122 and transmitting in the vertical direction. The horizontal transmission path 124 is a register for transmitting the charges transmitted from the vertical transmission path 23 in the horizontal direction. The output amplifier 125 converts the charges transmitted from the horizontal transmission path 124 to voltage, and amplifies the voltage.

The CCD driver 115 generates vertical transmission pulses φV1 through φV4 for driving the vertical transmission path 23, horizontal transmission pulses φH1 and φH2 for driving the horizontal transmission path 124, and charge discharging pulses φSUB for discharging the charges accumulated in the photo-sensors 122. The pulse output operations by the CCD driver 115 are controlled by the TG circuit 114.

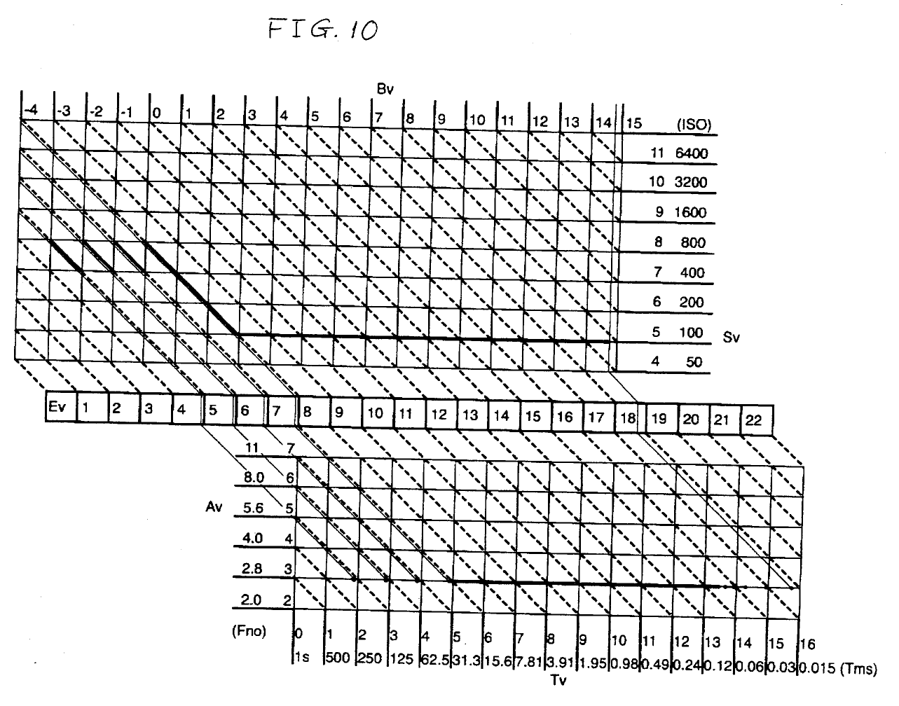

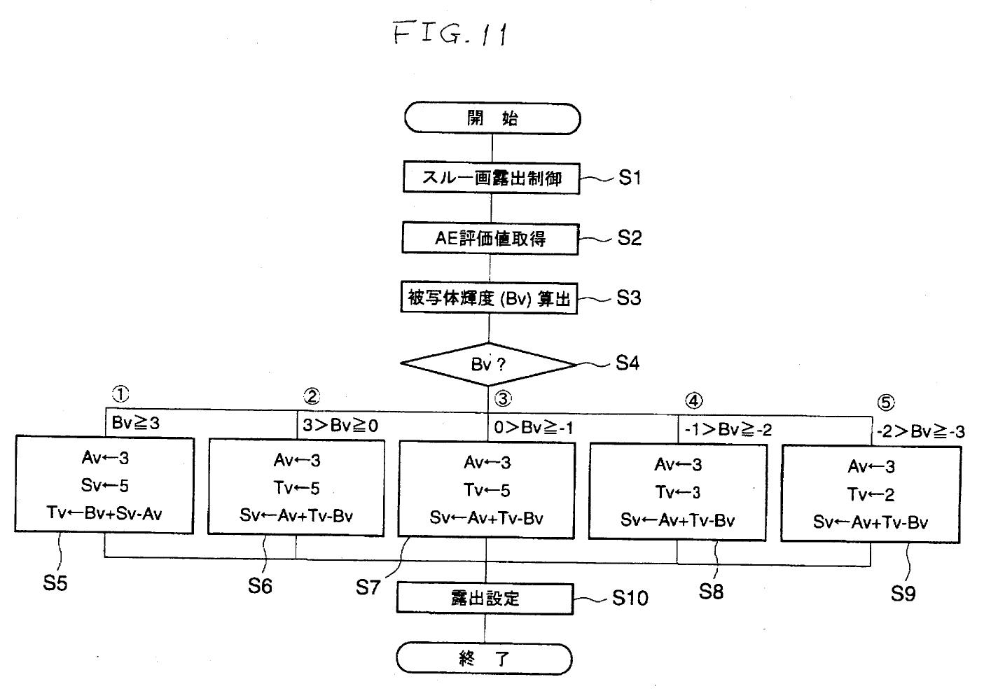

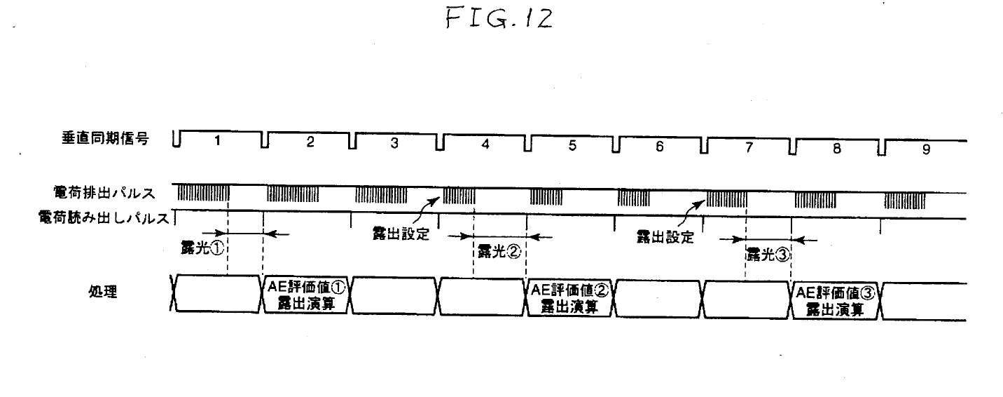

FIG. 10 is a program diagram which illustrates an exposure control method according to the present invention, and FIG. 11 is a flow diagram which schematically illustrates exposure control procedures. Now, description will be made regarding to the exposure control method according to the present invention with reference to FIG. 10 and FIG. 11.

In the event that the present digital camera displays a through-image (S1), the AE evaluation value is obtained from the image signals (S2), and the luminance of the image of the subject Bv is calculated based upon the AE evaluation value (S3). Subsequently, a method for exposure control is selected based upon the luminance value of the image of the subject Bv.

Note that, with the exposure computation, the apex computation shown in Expression (1) is used.

Ev=Av+Tv=Sv+Bv (1)

wherein Ev denotes the exposure, Av denotes the diaphragm, Tv denotes the shutter speed, and Sv denotes the amplification.

In the event that the luminance of the image of the subject Bv is equal to or greater than 3, the amplification Sv is taken as 5 (ISO=100), and the diaphragm Av is taken as 3 (Fno=2.8) according to the program diagram. Subsequently, the shutter speed Tv is obtained from the apex computation shown in Expression (2) (S5).

Tv=Sv+Bv−Av (2)

Subsequently, exposure is set using these values (S10).

FIG. 12 is a time chart indicates the operations of the exposure control.

In the event that the present digital camera displays a through-image, readout pulses are output synchronously with the intervals of the vertical synchronizing signals as shown in FIG. 12, the above-described exposure computation and exposure setting are repeatedly performed according to the sequence. Here, the interval of the vertical synchronizing signal will be referred to as a frame period.

In FIG. 12, the charges accumulated in the exposure duration denoted with the exposure \mathring{1} in the first frame period are read out in the second frame period, the AE evaluation value is calculated based upon the value, and the suitable exposure duration is computed with the above-described method. As a result, the obtained suitable exposure value is set in the third frame period, and is reflected in the exposure duration denoted by the exposure \mathring{2} in the fourth frame period.

In FIG. 11, in the event that the luminance of the image of the subject Bv is equal to or greater than 0 but less than 3, the shutter speed Tv is taken as 5 (shutter speed=1/30), and the diaphragm Av is taken as 3 (Fno=2.8) according to the program diagram. Subsequently, the amplification Sv is obtained from the apex computation shown in Expression (3) (S6).

Sv=Tv+Av−Bv (3)

Subsequently, exposure is set using these values (S10).

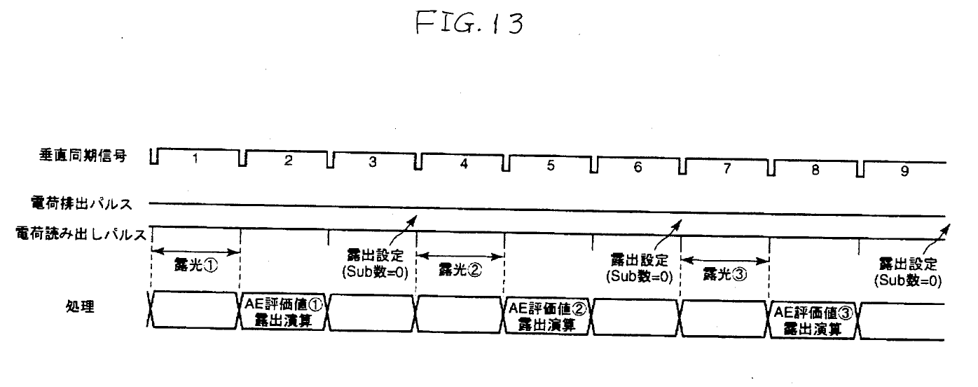

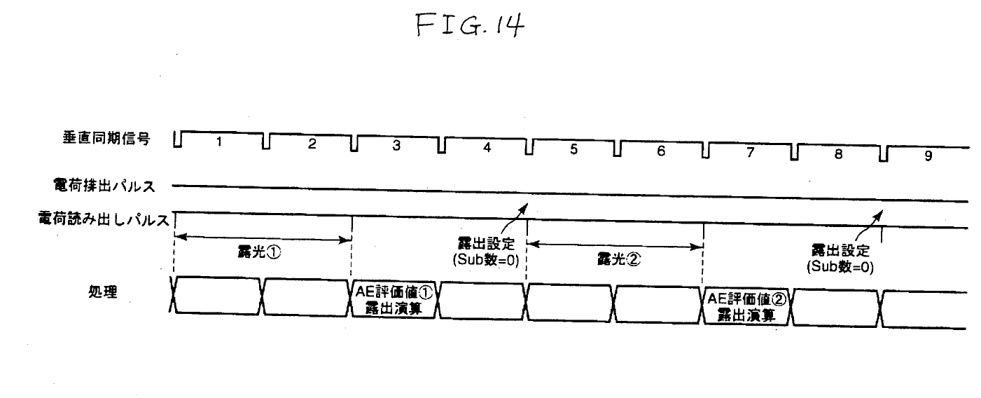

FIG. 13 is a time chart which illustrates the operations of the exposure control.

In FIG. 13, while the readout pulses are output synchronously with the intervals of the vertical synchronizing signals, the charge discharging pulses are not output, which is different from the case shown in FIG. 12. This is because discharging operations become unnecessary due to the shutter speed being matched with the cycle of the vertical synchronizing signals. Accordingly, in these operations, the charge discharging pulses are not output, so fluctuations of the substrate bias voltage does not occur, thereby obtaining a through-image without noise.

In FIG. 13, the charges accumulated in the exposure duration denoted by the exposure \mathring{1} in the first frame period are read out in the second frame period, the AE evaluation value is calculated based upon the value, and the computation with the exposure duration of 1/30 is performed using the above-described method. As a result, the obtained suitable exposure value is set, and also setting for stopping the output of the charge discharging pulses is performed, in the third frame period, and the suitable exposure value is reflected in the exposure duration denoted by the exposure \mathring{2} in the fourth frame period.

In FIG. 11, in the event that the luminance of the image of the subject Bv is equal to or greater than −1 but less than 0, the shutter speed Tv is taken as 4 (shutter speed=1/15), and the diaphragm Av is taken as 3 (Fno=2.8), according to the program diagram. Subsequently, the amplification Sv is obtained from the apex computation shown in Expression (3) (S7).

Subsequently, exposure is set using these values (S10).

FIG. 14 is a time chart which illustrates the operations of the exposure control.

In the drawing, the readout pulses are output synchronously with the period two times of the interval of the vertical synchronizing signals, and the charge discharging pulses are not output, which is different from the case shown in FIG. 12. This is because the shutter speed matches a double cycle of the vertical synchronizing signals, and accordingly, the discharging operations become unnecessary. Accordingly, with the present operations, the charge discharging pulses are not output, so the substrate bias voltage does not fluctuate, thereby obtaining a through-image without noise.

In FIG. 7, the charges accumulated in the exposure duration denoted by the exposure \mathring{1} in the first and second frame periods are read out in the third frame period, the AE evaluation value is calculated based upon the value, and the computation with the exposure duration of 1/15 is performed using the above-described method. As a result, the obtained suitable exposure value is set, and also setting for stopping the output of the charge discharging pulses is performed, in the fourth frame period, and the suitable exposure value is reflected in the exposure duration denoted by the exposure \mathring{2} in the fifth and sixth frame periods.

In FIG. 11, in the event that the luminance of the image of the subject Bv is equal to or greater than −2 but less than −1, the shutter speed Tv is taken as 3 (shutter speed=1/7.5), and the diaphragm Av is taken as 3 (Fno=2.8), according to the program diagram. Subsequently, the amplification Sv is obtained from the apex computation shown in Expression (3) (S8).

Subsequently, exposure is set using these values (S10).

FIG. 15 is a time chart which illustrates the operations of the exposure control.

In FIG. 15, the readout pulses are output synchronously with the period four times of the interval of the vertical synchronizing signals, and the charge discharging pulses are not output, which is different from the case shown in FIG. 12. This is because the shutter speed is made the same as a fourfold cycle of the vertical synchronizing signals, and accordingly, the discharging operations become unnecessary. Accordingly, with the present operations, the charge discharging pulses are not output, so the substrate bias voltage does not fluctuate, thereby obtaining a through-image without noise.

In FIG. 15, the charges accumulated in the exposure, duration denoted by the exposure \mathring{1} in the first through fourth frame periods are read out in the fifth frame period, the AE evaluation value is calculated based upon the value, and the computation with the exposure duration of 1/7.5 is performed using the above-described method. As a result, the obtained suitable exposure value is set, and also setting for stopping the output of the charge discharging pulses is performed, in the eighth frame period, and the suitable exposure value is reflected in the exposure duration in the following frame periods.

In FIG. 11, in the event that the luminance of the image of the subject Bv is equal to or greater than −3 but less than −2, the shutter speed Tv is taken as 2 (shutter speed=1/3.75), and the diaphragm Av is taken as 3 (Fno=2.8), according to the program diagram. Subsequently, the amplification Sv is obtained from the apex computation shown in Expression (3) (S9).

Subsequently, exposure is set using these values (S10).

With the exposure control operations, the readout pulses are output synchronously with the period eight times of the interval of the vertical synchronizing signals, in the same way as the above-described operations, and the charge discharging pulses are not output, which is different from the case shown in FIG. 12. Accordingly, with the present operations, the charge discharging pulses are not output, so the substrate bias voltage does not fluctuate, thereby obtaining a through-image without noise.

Note that while the present embodiment employs an arrangement wherein in the event that the luminance of the image of the subject Bv is less than 3 and charge discharging pulses are suppressed, the present invention is not intended to be restricted to this arrangement, but rather an arrangement may be made wherein in the event that the luminance of the image of the subject Bv is less than a value other than 3, the charge discharging pulses are suppressed. Furthermore, an arrangement may be made wherein at that time, the values of the shutter speed Tv and the diaphragm Av may be suitably selected.

Also while the present embodiment employs an arrangement wherein readout pulses are output synchronously with a period which has a duration of an even multiple of the interval of the vertical synchronizing signals, the present invention is not intended to be restricted to this arrangement, but rather an arrangement may be made wherein readout pulses are output synchronously with a period which has a duration of an integral multiple of the interval of the vertical synchronizing signals.

Furthermore, while, with the exposure control according to the program diagram, exposure is controlled by adjusting the amplification Sv, an arrangement may be made wherein exposure is controlled by adjusting the diaphragm Av.

Also, while description has been made regarding the noise reduction method for a through-image in the present embodiment, the present invention is not intended to be restricted to the embodiment, but rather an arrangement may be easily made by one skilled in the art.

Note that each function according to the present invention can be realized by being installed in the main CPU 1 as a program, or can be configured using hardware.

Note that the above-described embodiment includes various stages of inventions, so various inventions can be extracted by making suitable combinations of the disclosed multiple components. For example, a configuration may be extracted as an invention wherein several components are omitted from all the components shown in the embodiments, and the effects according to the present invention are obtained.

With the second embodiment of the present invention as described above with reference to FIG. 8 through FIG. 15, even in the event that the luminance of the image of the subject is low, an image can be obtained without mixture of noise caused by the fluctuation of the substrate bias voltage.

Next, description will be made regarding a third embodiment according to the present invention.

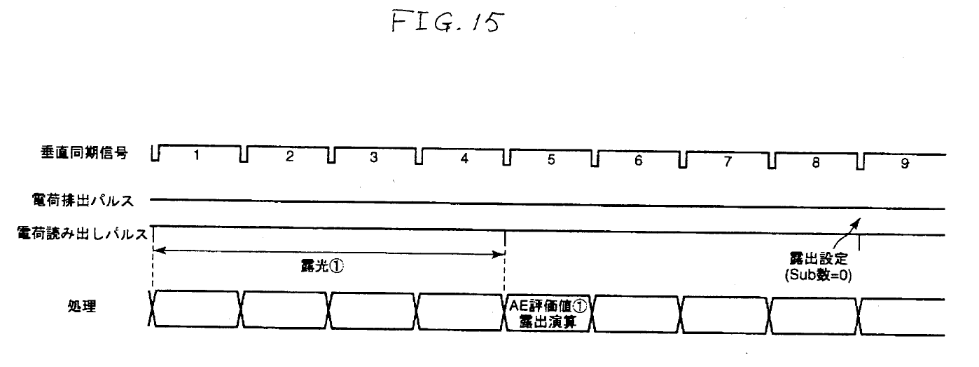

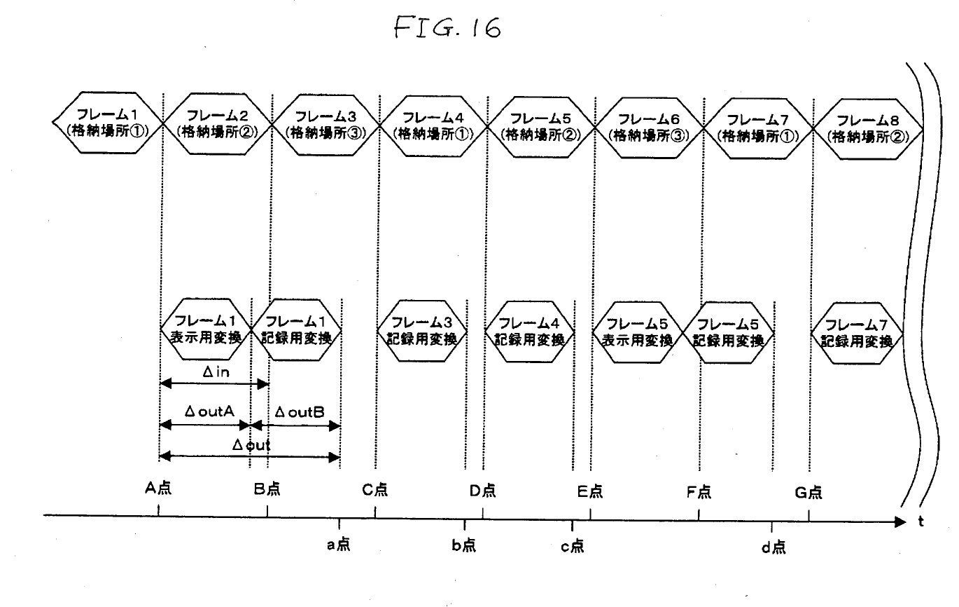

FIG. 16 is a time chart example of image format conversion processing performed by the digital camera according to the third embodiment of the present invention.

On the upper side in FIG. 16, a diagram illustrates the original image data, which is sequentially stored in the temporary memory unit, being arrayed over time in the direction of time axis t in increments of frames.

Reference characters point A through point G denoted on the time axis t shown in FIG. 16 indicate the points wherein each frame shown on the upper side in FIG. 16 is switched, as with those denoted on the time axis. Furthermore, reference characters point a through point d on the time axis t shown in FIG. 16 indicate the points wherein recording image format conversion processing for the original data in increments of frames ends, the same as those on the time axis t.

On the lower side in FIG. 16, the manner in which image format conversion processing for displaying and recording is performed for predetermined frames of the original image data with a ratio of one to three, is indicated corresponding to the time axis t.

Now, in FIG. 16, Δin denotes the time period from the original image data of one frame of the subject having been written to the temporary memory unit up to the original image data of the next frame being written to the temporary memory unit, and Δout denotes the period of the sum of the time period wherein the original image data of one frame stored in the temporary memory unit is read out and converted into the image data for displaying (ΔoutA) and the time period wherein the original image data stored in the temporary memory unit is read out and converted into the image data for recording (ΔoutB).

Furthermore, in FIG. 16, let us say that the relation Δin<Δout<2*Δin and Δin>ΔoutB holds, wherein “*” denotes a computation symbol of multiplication.

A hexagonal box shown in FIG. 16 indicates processing for the moving image of one frame as a unit, and the processing time and processing order correspond to the direction of the time axis t in the drawing.

On the lower side in FIG. 16, the manner in which the displaying image conversion processing and the recording image conversion processing are performed for the original image data of frame 1 shown on the upper side in FIG. 16 wherein temporary storage has been completed at the point A on the time axis t in the order shown in the drawing, is illustrated.

In FIG. 16, the point in time at which the recording image format conversion processing for the frame 1 ends is denoted with the point a on the time axis t, and at the point a, temporary storage for the frame 2 in the temporary memory unit is completed, and the temporary storage for the frame 3 has been started, as found from the relation Δin<Δout<2*Δin.

Also, on the lower side in FIG. 16, processing is in standby until the temporary storage of the frame 3 has been completed as shown on the upper side in FIG. 16, and from the point C on the time axis t, at which the temporary storage of the frame 3 has been completed, the second recording image format conversion processing starts for the frame 3, not for the frame 2, wherein the temporary storage has been just completed. The recording image formation conversion processing is completed at the point b prior to the point D on the time axis t, at which the frame 4 shown on the upper side in FIG. 16 is temporarily stored, as found from the relation Δin>ΔΔoutB. Upon the temporary storage for the frame 4 being completed at the point D on the time axis t shown on the upper side in FIG. 16, the third recording image format conversion processing is started for the frame 4. The processing is completed at the point c prior to the point E on the time axis t, at which the frame 5 shown on the upper side in FIG. 16 is temporarily stored in the same way as with the second recording image format conversion processing. With the present example, the ratio of the image format conversion processing amount for displaying as to that for recording is set to a ratio one to three, and accordingly, from the following point E on the time axis t, image formation conversion processing for displaying and recording is performed for the frame 5 in the order as shown in the drawing. The recording image format conversion processing is completed at the point d on the time axis t following which only the recording image format conversion processing is performed for the frame 7 from the point G on the time axis t, for the frame 7 where the temporary storage processing has been completed, and also, only the recording image format conversion processing is performed for the following frame 8 in the same way, which is not shown in the drawings. Furthermore, with the following processing, the processing pattern from the point A up to the point E on the time axis t shown on the lower side in FIG. 16 is repeatedly performed for the frames corresponding to the frames shown on the upper side in FIG. 16.

As described above, with the present example, the frame immediately following the frame subjected to image format conversion processing for displaying and recording is skipped, following which only the recording image format conversion processing is sequentially performed for the following two frames, and subsequently, the initial processing, i.e., the image format conversion processing for displaying and recording is performed for the further following one frame, and such a series of processing is repeatedly performed for the following frames.

Note that, with the present example, while an assumption has been made that the relation of Δin<Δout<2*Δin and Δin>ΔoutB holds, making an assumption that the relation of (α−1)*Δin<Δout<α*Δin and Δin>ΔoutB holds (each reference character is the same as described above), the (α−1) number of frames immediately following the frame subjected to image format conversion processing for displaying and recording are skipped over each image format conversion processing, following which only the recording image format conversion processing is sequentially performed for the following two frames, and subsequently the initial processing, i.e., the image format conversion processing for displaying and recording is performed for the further subsequent one frame, and such a series of processing is repeatedly performed for the following frames.

Furthermore, making an assumption that the relation of (α−1)*Δin<Δout<α*Δin and (α−2) Δin<ΔoutB<(α−1) Δin holds, the α−1 frames immediately following the frame subjected to image format conversion processing for displaying and recording are skipped over each image format conversion processing, following which only the recording image format conversion processing is sequentially performed for the following one frame, the further following α−2 frames are skipped over image format conversion processing, further following which only the recording image format conversion processing is performed for the following one frame, the further following α−2 frames are skipped over image format conversion processing, and subsequently, the initial processing, i.e., the image format conversion processing for displaying and recording is performed for the further following one frame, and such a series of processing is repeatedly performed for the following frames.

Also, while with the present example, the image format conversion processing for display and recording is performed from the frame 1, an arrangement may be made wherein only the image format conversion processing for recording is performed for frame 1, and the image format conversion processing for display and recording is performed from the frame 2, and an arrangement may be made wherein only the image format conversion processing for recording is performed for frame 2, as well, and the image format conversion processing for display and recording is performed from the frame 3.

Also, while with the present example, the image format conversion processing for display is performed prior to the image format conversion processing for recording with regard to the order of the image format conversion processing, an arrangement may be made wherein the image format conversion processing for recording is performed prior to the image format conversion processing for displaying.

Also, while with the present example, image format conversion processing for displaying and recording is performed with one out of four frames shown on the upper side in FIG. 16 being skipped, the recording image format conversion processing can be performed for all the original image data stored in the temporary memory unit by continuously performing image format conversion processing in the event that the sum of the time period for the image format conversion processing for displaying and recording and the time periods for following two times of recording image format conversion processing is less than the time period wherein the image data for three frames shown on the upper side in FIG. 16 is temporarily stored.

Also, while with the present example, the ratio of the frames subjected to the image format conversion processing for displaying as to the frames subjected to the image format conversion processing for recording is a ratio of one to three, the ratio can be arbitrary decided.

Furthermore, a great number of timing sequences can be determined, wherein displaying image format conversion processing can be performed without delay and various image format conversion processing can be performed, based upon the ratio, Δin, ΔoutA, ΔoutB, and the memory capacity of the temporary memory unit.

As described above, the number of frames subjected to the displaying image format conversion processing and the number of frames subjected to the recording image format conversion processing for a unit time period (with the present example, the time period between the point A and the point E) are adjusted so as to increase the number of frames subjected to the recording image format conversion processing by various methods, e.g., the method wherein the number of frames of recording image data to be generated is made greater than that of the displaying image data, the method wherein the number of frames of the recording image data is increased by reducing the number of frames of the displaying image data to be generated, the method wherein the numbers of frames of the recording image data and displaying image data, to be generated, are relatively adjusted, and the method wherein the first image format conversion for sequentially performing image format conversion into both displaying image data and recording image data and the second image format conversion for performing image format conversion into only recording image data are chronologically performed, when sequentially performing image format conversion of the original image data. Note that, with the displaying image format conversion processing, the conversion processing is performed immediately following the frame to be subjected to conversion having been stored in the temporary memory unit.

Thus, various image format conversion processing is performed according to such a time sequence so as to increase the frame rate of the recording image data, thereby realizing reproduction of moving images naturally. Furthermore, the displaying image format conversion processing is performed each time substantially immediately following temporary storage of the frame to be subjected to conversion, so delay never occurs between the actual moving images and the displayed moving images, and thus, the operator can shoot images at ease without confusion.

Note that even if the moving images show unnatural motion on the display unit when shooting moving images due to thinning out of frames subjected to the displaying image format conversion processing, the operator never feels the difference in time between the updated image on the display unit and the actual moving image, and thus the operator can shoot moving images at ease.

Furthermore, with the recording image data thus generated, empty data forming one frame or a copy of the preceding frame or immediately following frame may be provided at a position corresponding to the frame which has not been subjected to recording image format conversion. Thus, the recording image data, which is reproduced at the same speed as in shooting moving images, is reproduced at the same speed as the motion of the subject when shooting moving images, thereby reproducing the natural motion of the subject.

Next, description will be made below regarding a case wherein the digital camera is configured so as to perform the processing shown in the time chart in FIG. 16.

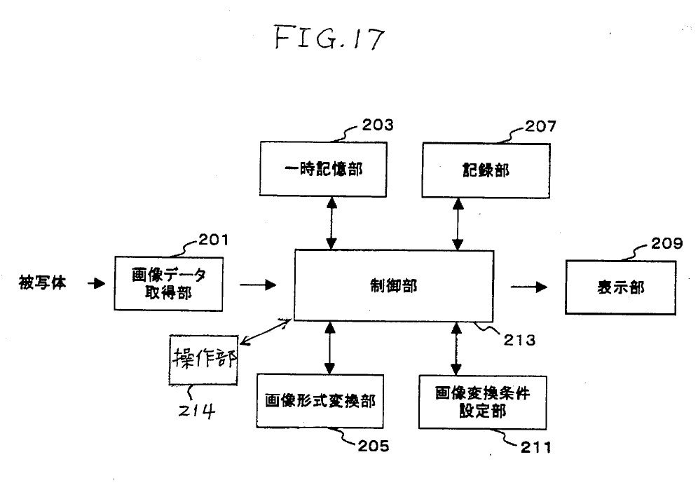

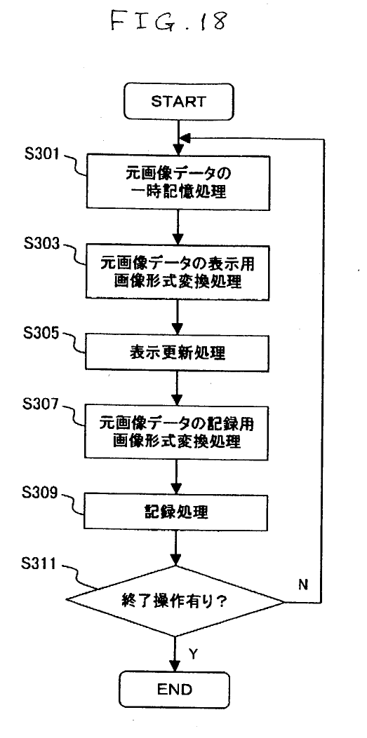

FIG. 17 is a block diagram which illustrates a moving image processing system included in the digital camera according to a third embodiment.

In the block diagram shown in FIG. 17, the moving image processing system comprises an image data acquisition unit 201, a temporary memory unit 203, an image format conversion unit 205, a memory unit 207, a display unit 209, an image conversion condition setting unit 211, a control unit 213, and an operating unit 214.

The image data acquisition unit 201 acquires the image of the subject from an image pickup device such as a CCD which is driven according to a predetermined clock rate, for example, as analog electric signals, the electric signals are subjected to gain adjustment and/or noise removal processing through various circuits, and finally, the electric signals are converted into digital data by an A/D conversion circuit.

The temporary memory unit 203 is made up of RAM (Random Access Memory) such as DRAM (Dynamic Random Access Memory), SRAM (Static Random Access Memory), or the like, temporarily stores the digital data (original image data) generated by the image data acquisition unit 201, temporarily stores the digital data subjected to conversion processing, and temporarily stores the data read out from the recording unit 207.

The image format conversion unit 205 performs image format conversion for the original data stored in the temporary memory unit 203 into displaying image data to be displayed on the display unit 209, or for the recording image data to be recorded in the recording unit 207, and performs thinning-out expansion processing for the recording image data recorded in the recording unit 207, for displaying. The image format conversion according to the present example indicates displaying image format conversion such as color signal processing, resizing processing, gamma conversion processing, and the like, for displaying image data, and for recording image data, the image format conversion indicates recording image format conversion further including image compression processing of the motion JPEG in addition to image processing in the aforementioned displaying image format conversion.

The recording unit 207 is made up of a portable recording medium detachable from the digital camera main unit such as a memory card, for example, and records the recording image data generated by the image format conversion unit 205.

The display unit 209 is made up of a display such as a liquid crystal panel, for example, and displays the displaying image data generated by the image format conversion unit 205, the reproduced data from the recording image data recorded in the recording unit 207, or various kinds of menu screens.

With the image conversion condition setting unit 211, the operator can set processing conditions for the displaying image format conversion processing and recording image format conversion processing performed by the image format conversion unit 205.

Roughly classifying the processing conditions, the processing conditions include a condition that the number of frames of the recording image data to be generated is greater than that of the displaying image data, a condition that the number of the frames of the recording image data is increased by reducing the frames of the displaying image data to be generated, a condition that the number of frames of the recording image data to be generated and the number of frames of the displaying image data to be generated are relatively adjusted, and a condition that the first image format conversion for sequentially performing image format conversion into both displaying image data and recording image data and the second image format conversion for performing image format conversion into only recording image data are chronologically performed, when sequentially performing image format conversion of the original image data, and specifically, there is a ratio of one to three, which is a ratio of the number of frames to be subjected to the displaying image format conversion processing as to the number of frames to be subjected to the recording image formation conversion processing for each unit time period, as shown in FIG. 16, as an example.

Such conditions can be set by selecting or inputting desired conditions on a condition setting screen displayed on the display unit 209 by the operations from the operating unit 214 of the digital camera main unit as shown in FIG. 17, for example.

The control unit 213 performs predetermined programs in the central processing unit (CPU) for performing various computations, performs DMA (Direct Memory Access) transmission, or the like, so as to control each unit described above.

FIG. 18 illustrates an operation example of the control unit 213 in the event that image shooting for moving image is performed with the digital camera having the above-described moving image processing system.

The operation of the control unit 213 shown in FIG. 18 is started based upon the starting operation for moving image shooting operated from the operating unit 214 of the digital camera main unit shown in FIG. 17, e.g., the pressing operation of the release button.

Now, upon the starting operation being made for shooting moving image from the aforementioned operating unit 214, first of all, the control unit 213 transmits the original image data in each predetermined unit (e.g., in each unit of several lines) sequentially output from the image data acquisition unit 201 to the temporary memory unit 203 using the DMA transmission so that the temporary memory unit 203 stores the original image data (S301). Subsequently, the original image data is consecutively read out from the temporary memory unit 203 in each predetermined unit, and the original image data of one frame is subjected to the displaying image format conversion processing by the image format conversion unit 205 based upon the processing conditions for displaying image format conversion which have been set by the image conversion condition setting unit 211 in a default manner, or based upon the processing conditions for the displaying image format conversion which have been set by the operating unit 214, whereby a displaying image data is generated (S303). Upon the displaying image data of one frame being generated in Step S303, the displaying image data is displayed on the display unit 209, and in the event that a previous displaying image data is displayed on the display unit 209, the previous displaying image data is updated (S305). Subsequently, the recording image format conversion processing is performed for the same original image data of one frame by the image format conversion unit 205 based upon the processing conditions for the recording image format conversion set by the image conversion condition setting unit 211 in a default manner, or the processing conditions for the recording image format conversion set by the operating unit 214, whereby a recording image data is generated (S307). In Step S307, upon the recording image data of one frame being generated, the recording image data is recorded in the recording unit 207 (S309). The processing in Step S301 through Step S309 is repeatedly performed until a determination is made in Step S311 that the ending operations for shooting moving images are performed by the aforementioned operating unit 214, and upon a determination being made in Step S311 that the ending operations for moving image shooting, e.g., the operation of pressing the release button again, or the like, are performed by the aforementioned operating unit 214, the processing ends.

Also, while in FIG. 18, the recording image format conversion processing is performed following the displaying image format conversion processing, an arrangement may be made wherein following the recording image format conversion processing, the displaying image format conversion processing is performed.

Also, with the image format conversion unit 205, with an arrangement wherein conversion processing from the displaying image data into the recording image data, or conversion processing from the recording image data into the displaying image data, is performed, the image format conversion unit 205 can generate the recording image data from the displaying image data generated based upon the original image data stored in the temporary memory unit 203, and generate the displaying image data from the recording image data generated based upon the original image data stored in the temporary memory unit 203.

Also, while an example has been shown wherein the timing for recording image data in the recording unit 207 is set for each time that recording image data of one frame has been generated, the timing for recording may be suitably set, for example, an arrangement may be made wherein all the recording image data is stored in the temporary memory unit 203, and following moving-image shooting, the recording image data is recorded in the recording unit 207 at a time.

The recording image data of the moving image shot by the digital camera having such a configuration forms moving images by reproducing each frame at the same intervals in time as in recording. In the event that the amount of the recording image format conversion processing in each unit time period exceeds the amount of the displaying image format conversion processing, the density of the still images forming the reproduced moving images becomes high in each unit time period, so the quality of the moving image is improved.

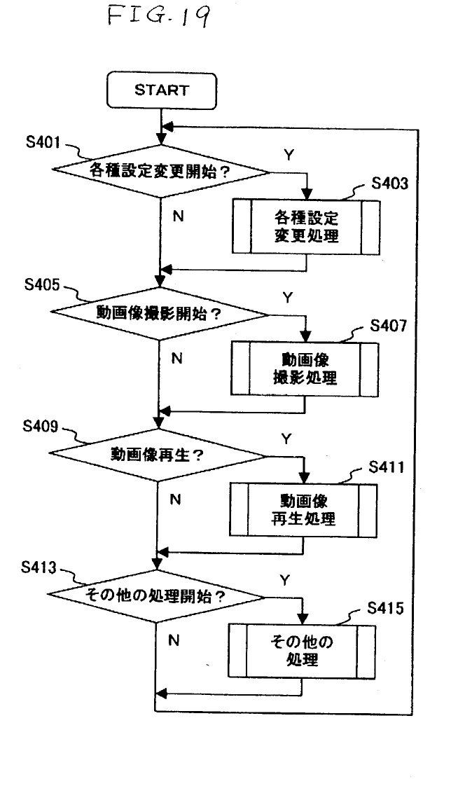

Next, the processing corresponding to the above-described moving image shooting will be described with reference to FIG. 19 through FIG. 22. Let us say that in the following description, multiple setting items, modes, or moving image shooting conditions are displayed on the display unit 209 so as to be listed in the vertical direction so that the operator can select these multiple setting items, modes, or the moving image shooting conditions by specifying the item with a cursor displayed on the screen.

Also, with each operation as described below, a release button is operated for starting moving image shooting, a direction command button is operated for the movement of the cursor on the screen, an OK button is operated for determination of the item specified by the cursor, a cancel button is operated for canceling of the processing, and an end button is operated for ending the setting screen, and each of these buttons is configured on the operating unit 214 shown in FIG. 17.

FIG. 19 illustrates a processing flow example performed by the control unit 213 for the operator selecting predetermined items from the processing for moving image including the above-described moving-image shooting.

As shown in FIG. 19, the control unit 213 stands by until the start command for processing with regard to moving images (the start command for various setting changing processing, the start command for moving-image shooting, and the start command for moving-image reproducing processing) or the start command for other processing is input from the operating unit 214.

Note that the settings changing processing is a processing for setting the processing conditions in image format conversion processing, for image displaying and recording, performed in moving-image shooting, and the moving-image reproducing processing is a processing for reproducing the recording image data recorded in the recording unit 207 in moving-image shooting so that the reproduced data is reproduced on the display unit 209.

In the event that the control unit 213 makes a judgment that the start command for various settings changing processing is input from the operating unit 214 (S401), the control unit 213 starts the various settings changing processing (S403), and upon the various settings changing processing ending in Step S403, the flow returns to the aforementioned standby state.

Also, in the event that the control unit 213 makes a judgment that the start command for moving-image shooting is input from the operating unit 214 (S405), the control unit 213 starts moving-image shooting (S407), and performs the control shown in FIG. 3. Upon the moving-image shooting ending in Step S407, the flow returns to the aforementioned standby state.

Also, in the event that the control unit 213 makes a judgment that the start command for reproducing for moving images is input from the operating unit 214 (S409), the control unit 213 starts reproducing processing for moving images (S411), and upon the reproducing processing for moving-image ending in S411, the flow returns to the aforementioned standby state.

Also, in the event that the control unit 213 makes a judgment that the start command for other processing is input from the operating unit 214 (S413), the control unit 213 starts that other processing (S415), and upon that other processing ending in S415, the flow returns to the aforementioned standby state.

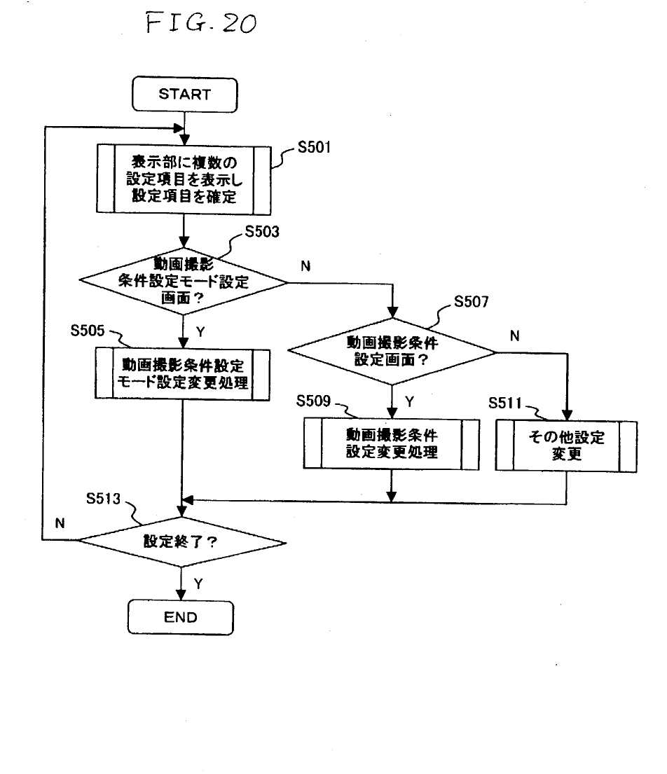

FIG. 20 illustrates an operation flow example for the control unit 213 according to the various settings changing processing shown in Step S403 in FIG. 19.

First of all, the operator displays multiple setting items on the display unit 209, moves a cursor to the setting item to be specified according to the command for upper and lower movement from the operating unit 214, and determines the setting item specified by the cursor according to the command for determination from the operating unit 214 (S501).

Subsequently, judgment is made whether or not the specified item is an item for setting the moving-image shooting conditions setting mode (S503), and in the event that judgment is made that the specified item is an item for setting the moving-image shooting conditions setting mode, the settings changing processing for the moving-image shooting conditions setting mode is started (S505).

In Step S503, in the event that judgment is made that the specified item is not an item for setting the moving-image shooting condition setting mode, judgment is made whether or not the specified item is an item for setting moving-image shooting conditions (S507), and in the event that judgment is made that the specified item is an item for setting the moving-image shooting conditions, the settings changing processing for moving-image shooting conditions is started (S509).

In Step S507, in the event that judgment is made that the specified item is not an item for setting the moving-image shooting conditions, the processing for changing other settings is started (S511).

Furthermore, upon the processing in Step S505, Step S509, or Step S511 ending, judgment is made whether or not the command for ending of various settings changing processing is input from the operating unit 214, and in the event that judgment is made that the command for ending is not input, the flow returns to the processing in Step S501, and the above-described processing in Step S501 through Step S513 is repeatedly performed. In Step S513, in the event that judgment is made that the command for ending is input, various settings changing processing ends.

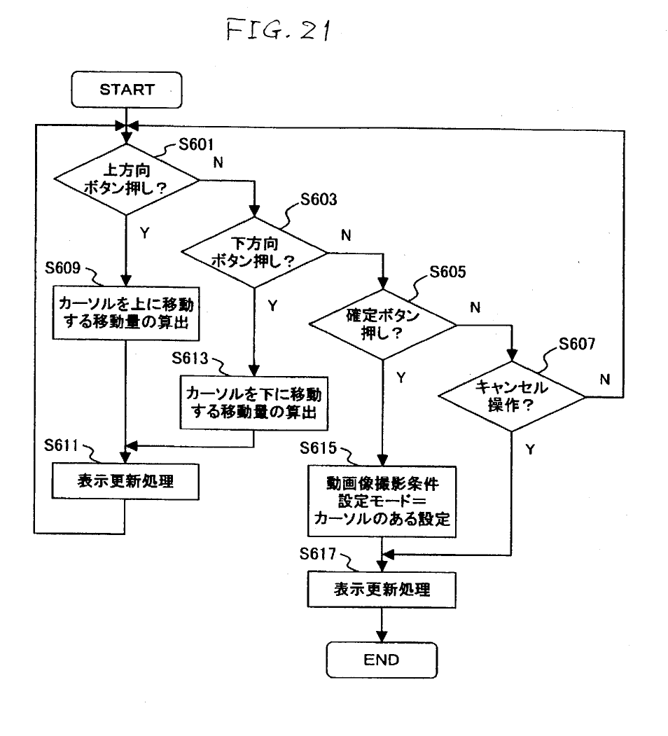

FIG. 21 is an operation flow example for the operating unit 213 regarding the settings changing processing for moving-image shooting condition setting mode shown in Step S505 in FIG. 20.

The control unit 213 judges whether or not the command for moving the cursor upward is input from the operating unit 214 (S601), whether or not the command for moving the cursor downward is input from the operating unit 214 (S603), whether or not the command for determination of the mode specified by the cursor is input from the operating unit 214 (S605), and whether or not the command for cancel of the present settings changing processing is input from the operating unit 214 (S607), in the state that the multiple modes which can be specified are displayed on the display unit 209, and stands by until judgment is made that one of the commands is input.

In Step S601, in the event that judgment is made that the command for moving the cursor upward is input from the operating unit 214, the movement amount is calculated for moving the cursor to the mode at a position one or multiple steps upward from the presently specified mode based upon the number of times of input or a time of duration of input (S609), and the display on the display unit 209 is updated (S611).

Also, in Step S601, in the event that judgment is made that the command for moving the cursor upward is not input from the operating unit 214, and in Step S603, judgment is made that the command for moving the cursor downward is input from the operating unit 214, the movement amount is calculated for moving the cursor to the mode at a position one or multiple steps downward from the presently specified mode based upon the number of times of input or a time of duration of input (S613), and the display on the display unit 209 is updated (S611). Upon updating of display on the display unit 209 being completed in Step S611, the processing is repeatedly performed from Step S601, in the same way.

Also, in the event that judgment is made that the command for moving the cursor downward is not input from the operating unit 214 in Step S603, and the command for determination of the mode specified by the cursor is input from the operating unit 214 in Step S605, the moving-image shooting condition setting mode which has been set in at default manner by the image conversion condition setting unit 211 is updated such that the moving-image shooting conditions setting mode is set to the mode specified by the cursor (S615).

Subsequently, the specified moving-image shooting conditions setting mode is displayed on the display unit 209 (S617), following which the present processing ends.

Also, in the event that judgment is made that the command for determination of the mode specified by the cursor is not input from the operating unit 214 in Step S605, and judgment is made that the command for cancel is input from the operating unit 214 in Step S607, the display is updated to the state of cancellation (S617), and the present processing ends.

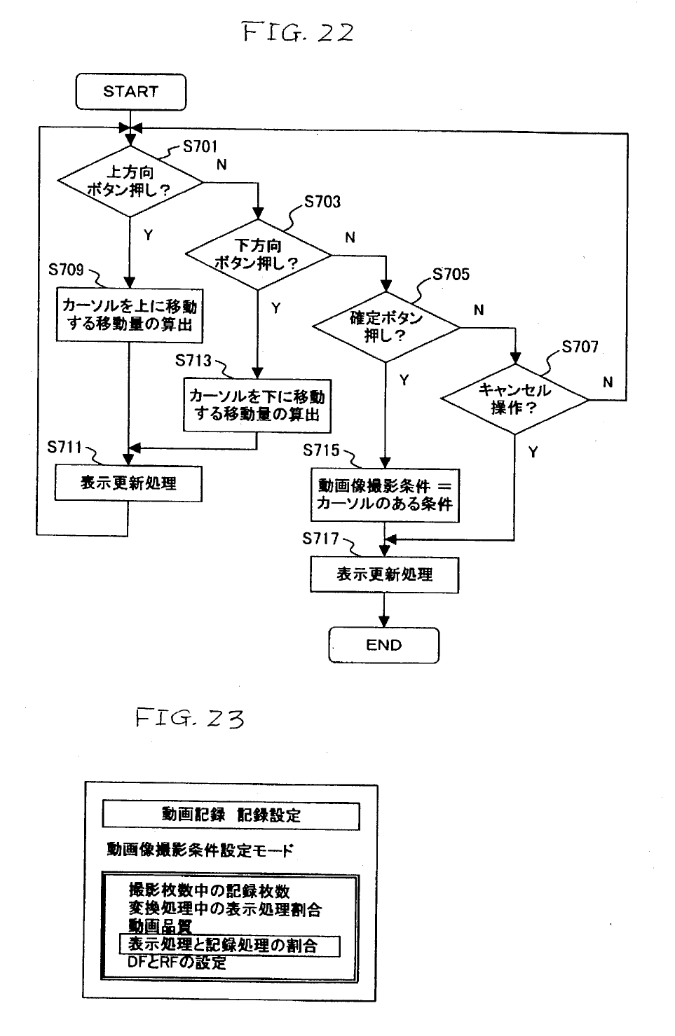

FIG. 22 illustrates an operation flow example for the control unit 213 with respect to the settings changing processing for moving-image shooting conditions shown in Step S509 in FIG. 20.

The control unit 213 judges whether or not the command for moving the cursor upward is input from the operating unit 214 (S701), whether or not the command for moving the cursor downward is input from the operating unit 214 (S703), whether or not the command for determination of the mode specified by the cursor is input from the operating unit 214 (S705), and whether or not the command for cancel of the present settings changing processing is input from the operating unit 214 (S707), in the state that the multiple modes which can be specified are displayed on the display unit 209, and stands by until judgment is made that one of the commands is input.

In Step S701, in the event that judgment is made that the command for moving the cursor upward is input from the operating unit 214, the movement amount is calculated for moving the cursor to the moving-image shooting condition at a position one or multiple steps upward from the presently specified moving-image shooting condition based upon the number of times of input or a time of duration of input (S709), and the display on the display unit 209 is updated (S711).

Also, in Step S701, in the event that judgment is made that the command for moving the cursor upward is not input from the operating unit 214, and in Step S703, judgment is made that the command for moving the cursor downward is input from the operating unit 214, the movement amount is calculated for moving the cursor to the moving-image shooting condition at a position one or multiple steps downward from the presently specified moving-image shooting condition based upon the number of times of input or a time of duration of input (S713), and the display on the display unit 209 is updated (S711). Upon updating of the display on the display unit 209 being completed in Step S711, the processing is repeatedly performed from Step S701, in the same way.

Also, in the event that judgment is made that the command for moving the cursor downward is not input from the operating unit 214 in Step S703, and judgment is made that the command for determining the moving-image condition specified by the cursor is input from the operating unit 214 in Step S705, the moving-image shooting condition which has been set by the image conversion condition setting unit 211 is updated such that the moving-image shooting condition specified by the cursor is set to the image shooting condition at the time of shooting moving images (S715).

Subsequently, the specified moving-image shooting condition is displayed on the display unit 209 (S717), following which the present processing ends.

Also, in the event that judgment is made that the command for determining the moving-image shooting condition specified by the cursor is not input from the operating unit 214 in Step S705, and judgment is made that the command for cancel is input from the operating unit 214 in Step S707, the display is updated to the display of cancellation (S717), and the present processing ends.

Next, description will be made regarding an example of the modes or moving-image shooting conditions displayed on the display unit 209 in processing shown in FIG. 21 or FIG. 22 with reference to the display examples shown in FIG. 23 through FIG. 29.

Note that, with the present example, the modes or the moving-image shooting conditions are displayed so as to be listed in the vertical direction in the region surrounded by a double line on the displayed screen, and a cursor is indicated with a rectangle frame within the region surrounded by the double line.

FIG. 23 is an example of the modes displayed on the display unit 209 in the processing shown in FIG. 21.

As shown in the drawing, five kinds of modes (number of recording frames in shooting frames, ratio of frames subjected to display processing to frames subjected to conversion processing, quality of moving images, ratio of frames subjected to display processing to frames subjected to recording processing, setting of display frame rate (DF) and recording frame rate (RF)) are displayed as selectable modes in that order from the top as surrounded by the double line. Now, the mode “ratio between frames subjected to display processing and frames subjected to recording processing” is specified by the cursor.

The aforementioned mode “number of recording frames in shooting frames” is a mode wherein the ratio of the number of the frames subjected to recording image format conversion processing (or the number of images of generated recording image data) by the image format conversion unit 205 to the number of frames of the original image data stored in the temporary memory unit 203 for each unit time period is set.

The aforementioned mode “ratio of frames subjected to display processing to frames subjected to conversion processing” is a mode wherein the ratio of the number of the frames subjected to displaying image format conversion processing (or the number of images of generated displaying image data) to the number of frames of the original image data subjected to image format conversion processing by the image format conversion unit 205 for each unit time period is set.

The aforementioned mode “quality of moving images” is a mode wherein the smoothness of the motion of the moving images when reproducing moving images is set.

The aforementioned mode “ratio between frames subjected to display processing and frames subjected to recording processing” is a mode wherein the ratio of the number of frames subjected to displaying image format conversion by the image format conversion unit 205 for each unit time period (or the number of images of generated displaying image data) to the number of frames subjected to recording image format conversion (or the number of images of generated recording image data) is set.

The aforementioned mode “setting of DF and RF” is a mode wherein the frame rates for displaying image data and recording image data, generated by the image format conversion unit 205 for each unit time period, are set.

Note that the cursor within the region surrounded by the double line shown in FIG. 23 is moved step by step to a mode upwards or downwards according to the input from the direction button shown in FIG. 21, and the mode specified by the cursor is set to the image conversion condition setting unit 211 according to the input from the OK button shown in FIG. 21, in the same way as in FIG. 24 through FIG. 29, described below.

FIG. 24 is an example of the moving-image shooting conditions displayed on the display unit 209 in the processing shown in FIG. 22.

As shown in FIG. 24, three kinds of moving-image shooting conditions for further selecting detailed conditions for the mode “number of recording frames in shooting frames” shown in FIG. 23, (½ of shooting frames, ⅔ of shooting frames, and ¾ of shooting frames) are displayed as selectable moving-image shooting conditions in that order from the top as surrounded by the double line. Now, the mode “¾ of shooting frames” is specified by the cursor.

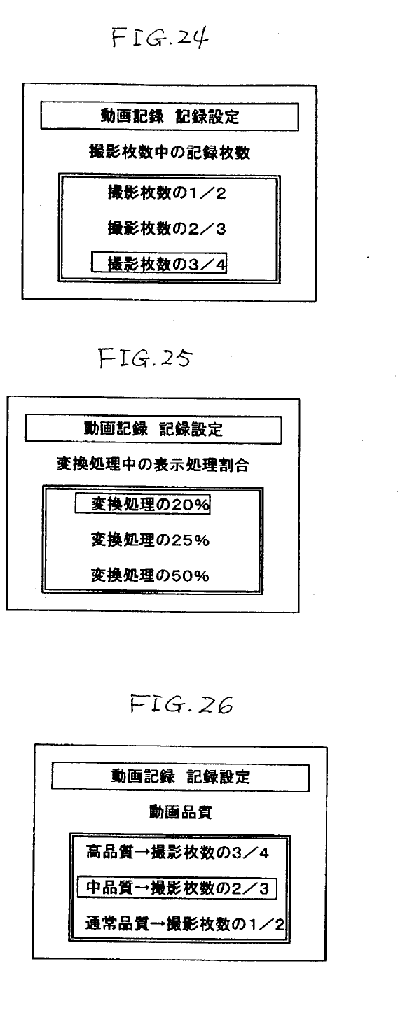

FIG. 25 is another example of the moving-image shooting conditions displayed on the display unit 209 in the processing shown in FIG. 22.

As shown in FIG. 25, three kinds of moving-image shooting conditions for further selecting detailed conditions for the mode “ratio of frames subjected to display processing to frames subjected to conversion processing” shown in FIG. 23, (20% of frames subjected to conversion processing, 25% of frames subjected to conversion processing, and 50% of frames subjected to conversion processing) are displayed as selectable moving-image shooting conditions in that order from the top as surrounded by the double line. Now, the mode “20% of frames subjected to conversion processing” is specified by the cursor.

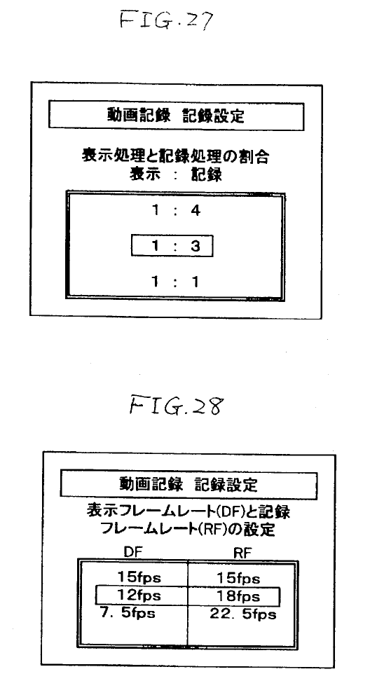

FIG. 26 is another example of the moving-image shooting conditions displayed on the display unit 209 in the processing shown in FIG. 22.

As shown in FIG. 26, three kinds of moving-image shooting conditions for further selecting detailed conditions for the mode “quality of moving images” shown in FIG. 8, (high quality→¾ of shooting frames, middle quality→⅔ of shooting frames, and normal quality→½ of shooting frames) are displayed as selectable moving-image shooting conditions in that order from the top as surrounded by the double line. Now, the mode “middle quality→⅔ of shooting frames” is specified by the cursor. Note that while the modes “high quality”, “middle quality”, and “normal quality” correspond to three moving-image shooting conditions shown in FIG. 24 indicated by the right arrow (→), (¾ of shooting frames, ⅔ of shooting frames, and ½ of shooting frames), respectively, as shown in FIG. 26, the modes “high quality”, “middle quality”, and “normal quality” may correspond to different image shooting conditions.

FIG. 27 is another example of the moving-image shooting conditions displayed on the display unit 209 in the processing shown in FIG. 22.

As shown in FIG. 27, three kinds of moving-image shooting conditions for further selecting detailed conditions for the mode “ratio of frames subjected to display processing to frames subjected to recording processing” shown in FIG. 23, (1:4, 1:3, and 1:1) are displayed as selectable moving-image shooting conditions in that order from the top as surrounded by the double line. Now, the mode “1:3” is specified by the cursor.

FIG. 28 is another example of the moving-image shooting conditions displayed on the display unit 209 in the processing shown in FIG. 22.

As shown in FIG. 28, three kinds of moving-image shooting conditions for further selecting detailed conditions for the mode “setting of DF and RF” shown in FIG. 23, (DF is set to 15 fps and RF is set to 15 fps, DF is set to 12 fps and RF is set to 18 fps, and DF is set to 7.5 fps and RF is set to 22.5 fps) are displayed as selectable moving-image shooting conditions in that order from the top as surrounded by the double line. Now, the mode “DF is set to 12 fps and RF is set to 18 fps” is specified by the cursor.

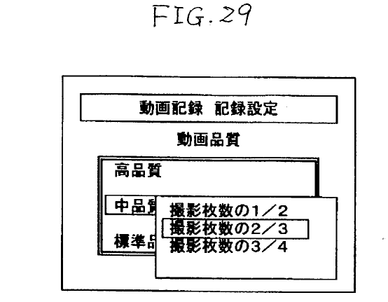

FIG. 29 is an example of combinations of multiple kinds of moving-image shooting conditions displayed on the display unit 209 in the processing shown in FIG. 22.

As surrounded by the double line shown in FIG. 29, three moving-image shooting conditions are displayed as selectable moving-image shooting conditions in that order from the top. Upon the operator specifying the moving-image shooting condition therefrom with the cursor, the operator can further make selection from different kinds of moving-image shooting conditions with a pull-down method.

With the present example, three kinds of moving-image shooting conditions for further selecting detailed conditions for the mode “quality of moving images” shown in FIG. 23, (high quality, middle quality, and normal quality) are displayed as selectable moving-image shooting conditions in that order from the top. Subsequently, the mode “middle quality” is specified therefrom by the cursor, and furthermore, the mode “⅔ of shooting frames” is specified from the three moving-image shooting conditions (½ of shooting frames, ⅔ of shooting frames, and ¾ of shooting frames), shown in FIG. 24, displayed with a pull-down method.

Note that, while with the present example, the mode “number of recording frames in shooting frames” shown in FIG. 24 is selected from the mode “quality of moving images” with a pull-down method, a different combination may be made.

Also, while with examples shown in FIG. 23 through FIG. 29, multiple modes or multiple moving-image shooting conditions are listed in the vertical direction, the list may be arbitrary arranged, so the modes or the moving-image shooting conditions may be listed in the horizontal direction.

Also, while with examples shown in FIG. 23 through FIG. 29, the modes or the moving-image shooting conditions are displayed within the region surrounded by the double line at a time, display format can be suitably decided using scroll display, pull-down display, a combination thereof, or the like.

Next, description will be made regarding an example of display control for the display unit 209 when shooting moving images or reproducing moving images.

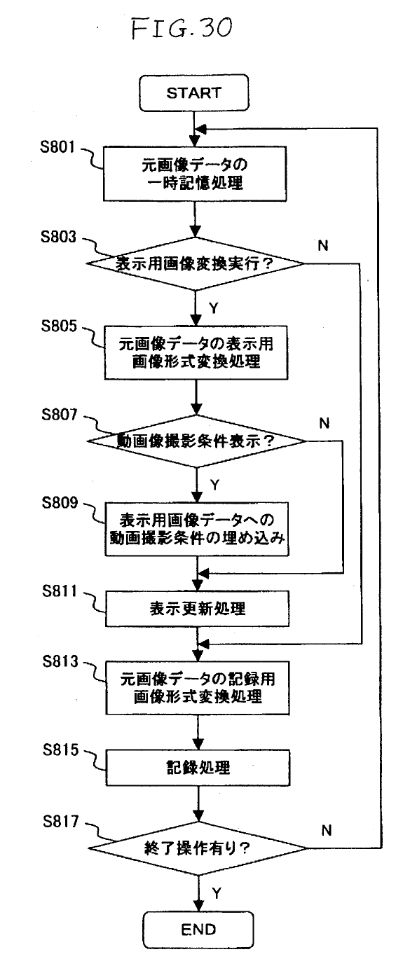

FIG. 30 illustrates a control example for the control unit 213 when moving images are shot in the event that settings can be made whether or not the moving-image shooting conditions are displayed on the display unit 209 when shooting moving images.

Note that with the present example, let us say that the moving-image shooting conditions can be further embedded in the generated displaying image data in the image format conversion unit 205 shown in FIG. 17, and the information with regard to the setting of “display/non-display” which indicates whether or not the moving-image shooting conditions are displayed on the display unit can be set in the image conversion condition setting unit 211 shown in FIG. 17.

The operations of the control unit 213 shown in FIG. 30 are started according to the starting operations for moving-image shooting operated from the operating unit 214 of the digital camera main unit.

Now, upon the operator operating the starting operations for shooting moving images from the aforementioned operating unit 214, first of all, the control unit 213 transmits the original image data in each predetermined unit (e.g., in each unit of several lines) using the DMA transmission, which is consecutively output from the image data acquisition unit 201, to the temporary memory unit 203 so that the temporary memory unit 203 consecutively stores the original image data (S801). Subsequently, the original image data is consecutively read out from the temporary memory unit 203 in each predetermined unit, judgment is made whether or not there is the need to perform displaying image format conversion processing for read original image data based upon the moving-image shooting conditions which have been set in the image conversion condition setting unit 211 in a default manner or on the moving-image shooting conditions of which settings have been changed by the operating unit 214 (S803), and in the event that there is the need to perform the displaying image format conversion processing for the original image data, the image format conversion unit 205 performs the displaying image format conversion processing for the original image data of one frame so as to generate the displaying image data (S805). Subsequently, judgment whether or not the moving-image shooting conditions are displayed is made based upon the setting of “display/non-display” which has been set by the image conversion condition setting unit 211 in a default manner, or based upon the setting of “display/non-display” of which setting has been changed by the operating unit 214 (S807). In Step S807, in the event that the moving-image shooting conditions have been judged to be displayed, by the image format conversion unit 205, the moving-image shooting conditions are embedded in the displaying image data (S809), the flow proceeds to the processing in Step S811. Conversely, in Step S807, in the event that judgment is made that the setting is “non-display”, the flow skips over the processing in Step S809, and the processing in Step S811 is performed. In Step S811, the generated displaying image data (including the displaying image data in which the moving-image conditions have been embedded) is displayed on the display unit 209, and in the event that previous displaying image data is displayed on the display unit 209, the previous displaying image data is updated (S811), and the flow proceeds to the processing in Step S813. Also, in Step S803, in the event that judgment is made that there is no need to perform displaying image format conversion processing for the original image data read out from the temporary memory unit 203, the processing in Step S805 through Step S811 is skipped, and the flow proceeds to the processing in Step S813. In Step S813, recording image format conversion processing is performed for the aforementioned original image data of one frame by the image format conversion unit 205, whereby recording image data is generated (S813). In the event that the recording image data of one frame is generated in Step S813, the recording image data is recorded in the recording unit 207 (S815). The processing from Step S801 up to Step S817 is repeatedly performed until judgment is made that the command for ending of moving-image shooting is input from the aforementioned operating unit 214 in Step S817, and conversely, in the event that judgment is made that the command for ending of moving-image shooting is input from the aforementioned operating unit 214, the present processing ends.

While an example has been shown in FIG. 30 wherein the recording image data is generated for all the original image data stored in the temporary memory unit 203, an arrangement may be made wherein in Step S813, judgment whether or not there is the need to perform the recording image format conversion processing for the original image data read out from the temporary memory unit 203 is made based upon the moving-image shooting conditions which have been set by the image conversion condition setting unit 211 in a default manner, or based upon the moving-image shooting conditions of which settings have been changed by the operating unit 214, and the recording image format conversion processing is performed for only the desired original image data.

Also, while an example has been shown wherein the recording image data is recorded in the recording unit 207 for each timing at which the recording image data of one frame has been generated, the timing for recording may be suitably set, for example, an arrangement may be made wherein all the recording image data is stored in the temporary memory unit 203, and following moving-image shooting, the recording image data is recorded in the recording unit 207 at a time.

Also, in the event that the conversion processing from the displaying image data into the recording image data, or the conversion processing from the recording image data into the displaying image data, is performed by the image format conversion unit 205, the recording image data can be generated from the displaying image data generated based upon the original image data stored in the temporary memory unit 203, or the displaying image data can be generated from the recording image data generated based upon the original image data stored in the temporary memory unit 203.

FIG. 31 is a display example in a case of displaying moving-image shooting conditions when shooting moving images.

The present example is a display example when moving images are shot in the event that the mode “ratio of frames subjected to displaying processing to frames subjected to recording processing” is “1:3” shown in FIG. 27 and the ratio is set to the image conversion condition setting unit 211 as a moving-image shooting condition. In the example in FIG. 31, while the modes “ratio of frames subjected to displaying processing to frames subjected to recording processing” and “1:3” are displayed on the upper portion on the moving image, the position and size for displaying, or displayed contents can be suitably set.

As described above, in the event that the moving-image shooting conditions are displayed when shooting moving images, the operator can easily confirm the moving-image shooting conditions, and accordingly, even if the moving image displayed on the display unit shows unnatural motion, the operator can easily confirm that the recording image data is being generated at a frame rate higher than that of the displaying image data, and thus the operator can shoot images at ease.

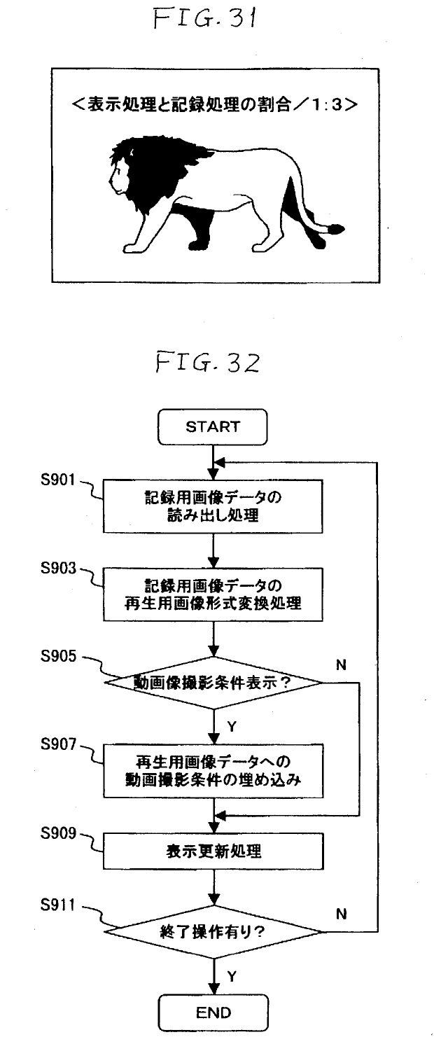

FIG. 32 illustrates a control example for the control unit 213 in the event that setting can be made whether or not the moving-image shooting conditions, which have been set in shooting moving images, are displayed on the display unit 209.

Furthermore, with the present example, the moving-image shooting conditions can be further embedded in the generated reproducing image data by the image format conversion unit 205 shown in FIG. 17, information with regard to “display/non-display” which indicates whether or not the moving-image shooting conditions are displayed on the display unit can be set by the image conversion condition setting unit 211 shown in FIG. 17, and the information with regard to the moving-image shooting conditions when shooting moving images is recorded on the recording unit 207 corresponding to the recording image data.

The present processing corresponds to the moving-image reproducing processing in Step S411 shown in FIG. 19.

First of all, the recording image data recorded in the recording unit 207 is read out to the temporary memory unit 203 (S901).

Subsequently, the recording image data read out to the temporary memory unit 203 is subjected to thinning-out expansion processing by the image format conversion unit 205, whereby reproducing image data is generated (S903).

Here, judgment is made whether or not the moving-image shooting conditions are displayed along with the aforementioned reproducing image data when reproducing the reproducing image data on the display unit 209 (S905).

In the event that the mode “display” of the moving-image shooting conditions is set to the image conversion condition setting unit 211, judgment is made that the moving-image shooting conditions are displayed along with the reproducing image data in Step S905, the information with regard to the moving-image shooting conditions is embedded in the reproducing image data (S907), and the flow proceeds to the processing in Step S909. Conversely, in the event that the mode “non-display” of the moving-image shooting conditions is set to the image conversion condition setting unit 211, judgment is made that the moving-image shooting conditions are not displayed along with the reproducing image data in Step S905, the processing in Step S907 is skipped, and the flow proceeds to the processing in Step S909.

In Step S909, the generated reproducing image data (including the reproducing image data in which the moving-image shooting conditions have been embedded) is displayed on the display unit 209, and in the event that a previous reproducing image data is displayed on the display unit 209, the previous reproducing image data is updated.

The processing from Step S901 through Step S909 is repeatedly performed until the command for stop of the moving-image reproducing processing is made by the operating unit 214.

In Step S911, in the event that judgment is made that the command for stop of the moving-image reproducing processing is input from the operating unit 214, the present processing ends.

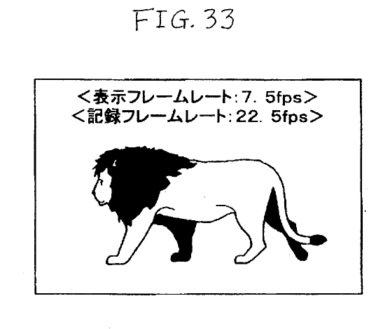

FIG. 33 is a display example of the moving-image shooting conditions when shooting moving images being displayed on the display screen when reproducing moving images.

The present example is an example wherein the recording image data shot with the moving-image shooting conditions of the mode “setting of DF and RF” of “DF is 7.5 fps and RF is 22.5 fps” shown in FIG. 28 is reproduced and displayed on the display unit 209 with settings for displaying the moving-image shooting conditions. In the example in FIG. 33, while the modes “display frame rate: 7.5 fps” and “record frame rate: 22.5 fps” are displayed on the upper portion on the moving image, the position and size for displaying or displayed contents can be suitably set.

Note that while description has been made regarding the digital camera as an example for description from FIG. 17 and thereafter, the present invention can be applied to any kind of image pickup device so long as the image pickup device consecutively performs storage and updating of the image signals, which is consecutively taken, in a predetermined range of a storage region, the image signals stored in the storage region are subjected to image format conversion into displaying image data or recording image data, and the image conversion processing amounts for displaying and recording for unit time period are adjusted, or the image conversion processing amount for recording exceeds the image conversion processing amount for displaying.

In the event of performing each image format conversion processing as described above, the frame rate of the recording image data can be increased, thereby realizing reproducing naturally when reproducing moving images. Furthermore, the displaying image format conversion processing is performed each time generally immediately following temporary storage of the frame to be subjected to conversion, delay does not occur between the actual moving images and the displayed moving images, and thus, the operator can take images at ease without confusion.

With the third embodiment of the present invention described with reference to FIG. 16 through FIG. 33, moving-image shooting can be performed with the frame rate of the recording image data being increased.

Having described the preferred embodiments of the invention referring to the accompanying drawings, it should be understood that the present invention is not limited to those precise embodiments and various changes and modifications thereof could be made by one skilled in the art without departing from the sprit or scope of the invention as defined in the appended claims.

Note that the present invention is not intended to be restricted to the embodiments above described, but rather, various modifications can be made without departing from the spirit of the present invention.

What is claimed is:

1. A digital camera, comprising:
an image pickup optical system for forming an image of a subject;
an image pickup device for generating image signals corresponding to light projected to its own image pickup screen by the image pickup optical system;
a trimming form selecting unit for selectively setting a trimming form which matches the object of use of an image to be recorded;
a first signal processing unit for subjecting the output of the image pickup device to signal processing such that an image can be observed in the trimming form selectively set by the trimming form selecting unit, and supplying to an applied electronic display unit;
a second signal processing unit for obtaining recording signals suitable for recording to a recording medium, in a form wherein partial loss of the image relating to trimming by the first signal processing unit does not occur based on the output of the image pickup device, and accompanied by trimming form identification signals representing the trimming form relating to the image which has been selectively set by the trimming form selecting unit;
a recording action activation unit for recording on an applied recording medium the image signals subjected to processing at the second signal processing unit in response to operation of a trigger unit; and
an image reproducing unit for reproducing the image signals recorded on the recording medium according to a form corresponding to the trimming form represented by the trimming form identification signals accompanying the image signals.

2. The digital camera according to claim 1, further comprising a mode switching unit for effective functioning of the first signal processing unit.

3. The digital camera according to claim 1, wherein the trimming form selecting unit comprises:
a trimming data storage unit for holding a plurality of types of trimming data for causing the first signal processing unit to perform trimming processing each corresponding to a plurality of trimming forms set beforehand; and
a selecting operating unit for selecting a particular one of the plurality of trimming forms corresponding to the trimming data held by the trimming data storage unit.

4. The digital camera according to claim 1, wherein the first signal processing unit is configured to perform processing including a process for subjecting the output of the image pickup device, in a format following the trimming form selectively set by the trimming form selecting unit, to a process for substituting data of the portion of the image to be removed by the trimming with mute signals, or a process for performing data processing essentially equivalent to this processing.

5. The digital camera according to claim 1, wherein the first signal processing unit is configured to perform mode switching between an action mode wherein signal processing is executed such that the image is observed according to a format following the trimming form selectively set by the trimming form selecting unit, and an action mode wherein the signals are allowed to pass without performing the signal processing.

6. The digital camera according to claim 1, wherein the first signal processing unit comprises:
a first signal transmitting path for subjecting the output of the image pickup device to signal processing such that an image can be observed according to a format following the trimming form selectively set by the trimming form selecting unit, and supplying to an applied electronic display unit;
a second signal transmitting path for supplying signals which are not subjected to the signal processing with regard to the output of the image pickup device, to the electronic display unit; and
a trimming/normal switching unit for allowing the first signal transmitting path and the second signal transmitting path to be switched between and applied according to timing arbitrarily decided by the operator.

7. The digital camera according to claim 6, wherein the trimming/normal switching unit is configured such that the first signal transmitting path is applied in the event that the operator applies operations to a predetermined operating unit, and the second signal transmitting path is applied in the event that the operator is not applying operations to the operating unit.

8. The digital camera according to claim 3, wherein the trimming form selecting unit further comprises a trimming menu display unit for taking a predetermined number of trimming forms of the plurality of trimming forms corresponding to the trimming data held in the trimming data storage unit, and displaying these together on the applied electronic display unit applied, as a menu screen;
and wherein the trimming form selecting unit is configured such that the operator can select an arbitrary one of the trimming forms displayed on the electronic display unit with the trimming menu display unit.

9. The digital camera according to claim 8, wherein the trimming form selecting unit is configured further comprising a manual trimming unit for selectively setting a trimming form corresponding to trimming data generated based on predetermined operations by the operator, in addition to the plurality of trimming forms corresponding to the trimming data held in the trimming data storage unit beforehand.

10. The digital camera according to claim 6, wherein the trimming/normal switching unit is configured such that the first signal transmitting path and the second signal transmitting path are switched between and applied by the operator at arbitrary timing, according to the switching operation to a predetermined switching switch.

11. The digital camera according to claim 6, wherein the trimming/normal switching unit is configured such that the first signal transmitting path and the second signal transmitting path are switched between and applied by the operator at an arbitrary timing according to the degree of operational amount of an operating unit in common use with the trigger unit.

12. The digital camera according to claim 1, wherein the image reproducing unit is configured so as to display a pattern, representing the trimming form that has been set by the trimming form selecting unit, at a position relatively offset to the periphery of the image where partial loss of the image relating to trimming substantially does not occur.

13. The digital camera according to claim 1, wherein the image reproducing unit is configured so as to display a reproduced image in a form as a result of trimming set by the trimming form selecting unit having been performed.

14. The digital camera according to claim 1, further comprising a shooting conditions automatic setting unit for automatically setting shooting conditions according to the trimming form selectively set by the trimming form selecting unit.

15. The digital camera according to claim 14, wherein the shooting conditions automatic setting unit is configured so as to automatically set shooting conditions, including settings relating to the number of pixels making up the recorded image, according to the trimming form selectively set by the trimming form selecting unit.

16. The digital camera according to claim 14, wherein the shooting conditions automatic setting unit is configured so as to automatically set shooting conditions, including settings for the compression ratio of information relating to the recorded image, according to the trimming form selectively set by the trimming form selecting unit.

17. The digital camera according to claim 14, wherein the shooting conditions automatic setting unit is configured so as to automatically set shooting conditions, including settings relating to the resolution of the recorded image, according to the trimming form selectively set by the trimming form selecting unit.

18. The digital camera according to claim 14, wherein the shooting conditions automatic setting unit is configured so as to automatically set shooting conditions, including settings relating to the color tone of the recorded image, according to the trimming form selectively set by the trimming form selecting unit.

19. The digital camera according to claim 14, wherein the shooting conditions automatic setting unit is configured so as to automatically set shooting conditions, including settings relating to image size, according to the trimming form selectively set by the trimming form selecting unit.

20. The digital camera according to claim 14, wherein the shooting conditions automatic setting unit is configured so as to automatically set shooting conditions, including settings relating to the diaphragm, according to the trimming form selectively set by the trimming form selecting unit.

21. The digital camera according to claim 14, wherein the shooting conditions automatic setting unit is configured so as to automatically set shooting conditions, including settings relating to the depth of field, according to the trimming form selectively set by the trimming form selecting unit.

22. The digital camera according to claim 14, wherein the shooting conditions automatic setting unit is configured so as to automatically set shooting conditions, including settings relating to the photometry method, according to the trimming form selectively set by the trimming form selecting unit.

23. The digital camera according to claim 14, wherein the shooting conditions automatic setting unit is configured so as to automatically set shooting conditions, including settings relating to turning the flash on and off, according to the trimming form selectively set by the trimming form selecting unit.

24. The digital camera according to claim 14, wherein the shooting conditions automatic setting unit is configured so as to automatically set shooting conditions, including settings relating to the manner in which the flash is lit to reduce red-eye, according to the trimming form selectively set by the trimming form selecting unit.

25. The digital camera according to claim 14, wherein the shooting conditions automatic setting unit is configured so as to automatically set shooting conditions, including settings relating to the contrast of the recorded image, according to the trimming form selectively set by the trimming form selecting unit.

26. The digital camera according to claim 14, wherein the shooting conditions automatic setting unit is configured so as to automatically set shooting conditions, including settings relating to the sharpness of the recorded image, according to the trimming form selectively set by the trimming form selecting unit.

27. The digital camera according to claim 14, wherein the shooting conditions automatic setting unit is configured so as to automatically set shooting conditions, including settings relating to gamma correction of the recorded image, according to the trimming form selectively set by the trimming form selecting unit.

28. The digital camera according to claim 14, wherein the shooting conditions automatic setting unit is configured so as to automatically set shooting conditions, including settings relating to brightness of the recorded image, according to the trimming form selectively set by the trimming form selecting unit.

29. The digital camera according to claim 14, wherein the shooting conditions automatic setting unit is configured so as to automatically set shooting conditions, including settings relating to the edges of the recorded image, according to the trimming form selectively set by the trimming form selecting unit.

30. The digital camera according to claim 14, wherein the shooting conditions automatic setting unit is configured so as to automatically set shooting conditions, including settings relating to shutter speed, according to the trimming form selectively set by the trimming form selecting unit.

31. The digital camera according to claim 14, wherein the shooting conditions automatic setting unit is configured so as to automatically set shooting conditions, including settings relating to the EV value, according to the trimming form selectively set by the trimming form selecting unit.

32. The digital camera according to claim 14, wherein the shooting conditions automatic setting unit is configured so as to automatically set shooting conditions, including settings relating to the white balance, according to the trimming form selectively set by the trimming form selecting unit.

33. The digital camera according to claim 14, wherein the shooting conditions automatic setting unit is configured so as to automatically set shooting conditions, including settings relating to the ISO sensitivity, according to the trimming form selectively set by the trimming form selecting unit.

34. The digital camera according to claim 14, wherein the shooting conditions automatic setting unit is configured so as to automatically set shooting conditions, including settings relating to the zoom magnification, according to the trimming form selectively set by the trimming form selecting unit.

35. The digital camera according to claim 14, wherein the shooting conditions automatic setting unit is configured so as to automatically set shooting conditions, including settings relating to the light emission amount of the flash, according to the trimming form selectively set by the trimming form selecting unit.

36. The digital camera according to claim 14, wherein the shooting conditions automatic setting unit is configured so as to automatically set shooting conditions, including settings relating to bracket image shooting, according to the trimming form selectively set by the trimming form selecting unit.

37. The digital camera according to claim 14, wherein the shooting conditions automatic setting unit is configured so as to automatically set shooting conditions, including settings relating to serial image shooting, according to the trimming form selectively set by the trimming form selecting unit.

38. The digital camera according to claim 14, wherein the shooting conditions automatic setting unit is configured so as to automatically set shooting conditions, including settings relating to the data format for image recording, according to the trimming form selectively set by the trimming form selecting unit.

39. The digital camera according to claim 14, wherein the shooting conditions automatic setting unit is configured so as to automatically set shooting conditions, including settings relating to DPOF (Digital Print Oder Format), according to the trimming form selectively set by the trimming form selecting unit.

40. The digital camera according to claim 14, further comprising a switching unit for switching between whether to select an automatic mode wherein the settings relating to the shooting conditions are automatically set or whether to select a manual mode wherein the settings relating to the shooting conditions are arbitrarily set manually, configured such that the shooting conditions automatic setting unit functions upon the automatic mode being selected by the switching unit.

41. The digital camera according to claim 3, wherein the trimming data storage unit of the trimming form selecting unit is configured so as to include a form wherein the portion of the image selectively removed by trimming becomes a black level, gray level, or color mute screen, as one of the plurality of types of trimming data.

42. The digital camera according to claim 3, wherein the trimming data storage unit of the trimming form selecting unit is configured so as to include a form wherein an image of the portion of the image selectively removed by trimming serving as a background is subjected to translucent masking, as one of the plurality of types of trimming data.

43. The digital camera according to claim 3, wherein the trimming form selecting unit, in addition to the plurality of trimming forms corresponding to the trimming data held in the trimming data storage unit beforehand, further comprises a manual trimming unit for selectively setting a trimming form corresponding to trimming data generated based on predetermined operations made by the operator.

44. A digital camera wherein the interval between charge discharging pulses applied to an image pickup device and charge read-out pulses are varied to control the charge accumulation amount of the image pickup device, the digital camera comprising:
a luminance calculating unit for obtaining subject luminance from imaging signals of the image pickup device; and
a charge accumulation time control unit for forbidding charge discharge of the image pickup device by the charge discharging pulses in the event that the obtained subject luminance is lower than a predetermined value, so as to control the charge accumulation time of the image pickup device in time intervals which are integral multiples of the vertical transfer period.

45. The digital camera according to claim 44, further comprising an exposure control unit for controlling the charge accumulation amount by amplification of output signals of the image pickup device or by diaphragm value, in the event that the charge accumulation time of the image pickup device is controlled in time intervals which are integral multiples of the vertical transfer period.

46. An image-pickup method with a digital camera wherein the interval between charge discharging pulses applied to an image pickup device and charge read-out pulses are varied to control the charge accumulation amount of the image pickup device, the method comprising:
obtaining subject luminance from imaging signals of the image pickup device; and
forbidding charge discharge of the image pickup device by the charge discharging pulses in the event that the obtained subject luminance is lower than a predetermined value, so as to control the charge accumulation time of the image pickup device in time intervals which are integral multiples of the vertical transfer period.

47. The image-pickup method with a digital camera according to claim 46, wherein the charge accumulation amount is controlled by amplification of output signals of the image pickup device or by diaphragm value, in the event that the charge accumulation time of the image pickup device is controlled in time intervals which are integral multiples of the vertical transfer period.

48. A digital camera comprising:
a temporary storage unit for sequentially performing storing of image signals sequentially captured and updating of the storage;
an image format converting unit for performing image format conversion of the image signals stored to generate through-image display image data or recording image data;
an image conversion conditions setting unit having settings wherein the number of images of the recording image data generated per unit time at the image format converting unit is greater than the number of images of through-image display image data generated per unit time at the image format converting unit; and
a control unit for performing image format conversion of image signals stored in the temporary storage unit into the through-image display image data or the recording image data in the image format converting unit, based on the settings in the image conversion conditions setting unit.

49. A digital camera comprising:
a temporary storage unit for sequentially performing storing of image signals sequentially captured and updating of the storage;
an image format converting unit for performing image format conversion of the image signals stored to generate through-image display image data or recording image data;
an image conversion conditions setting unit having settings wherein the number of images of the recording image data generated per unit time at the image format converting unit is increased, by reducing the number of images of through-image display image data generated per unit time in the image format converting unit; and
a control unit for performing image format conversion of image signals stored in the temporary storage unit into the through-image display image data or the recording image data in the image format converting unit, based on the settings in the image conversion conditions setting unit.

50. A digital camera comprising:
a temporary storage unit for sequentially performing storing of image signals sequentially image-picked-up and updating of the storage;
an image format converting unit for performing image format conversion of the image signals stored to generate through-image display image data or recording image data;
an image conversion conditions setting unit having settings for relatively changing the number of images of the recording image data generated per unit time in the image format converting unit and the number of images of through-image display image data generated per unit time at the image format converting unit; and
a control unit for performing image format conversion of image signals stored in the temporary storage unit into the through-image display image data or the recording image data in the image format converting unit, based on the settings in the image conversion conditions setting unit.

51. A digital camera comprising:
a temporary storage unit for sequentially performing storing of image signals sequentially taken and updating of the storage;
an image format converting unit for performing image format conversion of the image signals stored to generate through-image display image data or recording image data;
an image conversion conditions setting unit having settings wherein, at the time of sequentially performing image format conversion of the stored image signals, a first image format conversion for performing sequential image format conversion into both the through-image display image data and the recording image data, and a second image format conversion for performing image format conversion of the stored image signals into only the recording image data, are performed in time-sequence; and
a control unit for performing image format conversion of image signals stored in the temporary storage unit into the through-image display image data or the recording image data in the image format converting unit, based on the settings in the image conversion conditions setting unit.

52. The digital camera according to claim 48, wherein the image conversion conditions setting unit is set by the ratio of the number of images subjected to image format conversion from the images to the recording image data to the number of images configured per unit time with the image signals stored in the temporary storage unit.

53. The digital camera according to claim 48, wherein the image conversion conditions setting unit is set by the ratio of the number of images of through-image display image data generated per unit time in the image format converting unit to the number of images of recording image data generated per unit time at the image format converting unit.

54. The digital camera according to claim 48, wherein the image conversion conditions setting unit is set by the image quality of the recording image data;
and further wherein the image quality is correlated with the ratio of the number of images subjected to image format conversion from the images to recording image data to the number of image configured per unit time with image signals stored in the temporary storage unit.

55. The digital camera according to claim 48, wherein the image conversion conditions setting unit is set by the ratio between the number of images of through-image display image data generated per unit time in the image format converting unit and the number of images of recording image data generated per unit time at the image format converting unit.

56. The digital camera according to claim 48, wherein the image conversion conditions setting unit is set by a combination of the frame rate of through-image display image data generated in the image format converting unit and the frame rate of recording image data generated at the image format converting unit.

57. The digital camera according to claim 48, wherein the image conversion conditions setting unit is set to one of the modes of: a mode wherein setting is performed by the ratio of the number of images subjected to image format conversion from the images to the recording image data to the number of images configured per unit time with the image signals stored in the temporary storage unit; a mode wherein setting is performed by the ratio of the number of images of through-image display image data generated per unit time at the image format converting unit to the number of images of recording image data generated per unit time in the image format converting unit; a mode wherein setting is performed by the image quality of the recording image data, and further wherein the image quality is correlated with the ratio of the number of images subjected to image format conversion from the images to recording image data to the number of image configured per unit time with image signals stored in the temporary storage unit; a mode wherein setting is performed by the proportion between the number of images of through-display image data generated per unit time in the image format converting unit and the number of image of recording image data generated per unit time in the image format converting unit; and a mode wherein setting is performed by a combination of the frame rate of through-image display image data generated in the image format converting unit and the frame rate of recording image data generated in the image format converting unit.

58. The digital camera according to claim 48, wherein the image conversion conditions setting unit is capable of settings for the image quality of the recording image data, and further can set the ratio of images to be subjected to image format conversion from the images to the recording image data to the number of images configured per unit time of the image signals stored in the temporary storage unit, as to the set image quality.

59. The digital camera according to claim 48, further comprising a warning display unit for displaying the setting contents of the image conversion conditions setting unit; and
a recording unit capable of recording on a recording medium detachably mounted to the digital camera;
wherein display of the setting contents of the image conversion conditions setting unit is performed at the time of recording the recording image data, which has been subjected to image format conversion based on the setting contents of the image conversion conditions setting unit, in the recording unit.

60. The digital camera according to claim 52, further comprising a warning display unit for displaying the setting contents of the image conversion conditions setting unit; and
a recording unit capable of recording on a recording medium-detachably mounted to the digital camera;
wherein display of the setting contents of the image conversion conditions setting unit is performed at the time of recording the recording image data, which has been subjected to image format conversion based on the setting contents of the image conversion conditions setting unit, in the recording unit.

61. The digital camera according to claim 53, further comprising a warning display unit for displaying the setting contents of the image conversion conditions setting unit; and
a recording unit capable of recording on a recording medium detachably mounted to the digital camera;
wherein display of the setting contents of the image conversion conditions setting unit is performed at the time of recording the recording image data, which has been subjected to image format conversion based on the setting contents of the image conversion conditions setting unit, in the recording unit.

62. The digital camera according to claim 54, further comprising a warning display unit for displaying the setting contents of the image conversion conditions setting unit; and
a recording unit capable of recording on a recording medium detachably mounted to the digital camera;
wherein display of the setting contents of the image conversion conditions setting unit is performed at the time of recording the recording image data, which has been subjected to image format conversion based on the setting contents of the image conversion conditions setting unit, in the recording unit.

63. The digital camera according to claim 55, further comprising a warning display unit for displaying the setting contents of the image conversion conditions setting unit; and
a recording unit capable of recording on a recording medium detachably mounted to the digital camera;
wherein display of the setting contents of the image conversion conditions setting unit is performed at the time of recording the recording image data, which has been subjected to image format conversion based on the setting contents of the image conversion conditions setting unit, in the recording unit.

64. The digital camera according to claim 56, further comprising a warning display unit for displaying the setting contents of the image conversion conditions setting unit; and
a recording unit capable of recording on a recording medium detachably mounted to the digital camera;
wherein display of the setting contents of the image conversion conditions setting unit is performed at the time of recording the recording image data, which has been subjected to image format conversion based on the setting contents of the image conversion conditions setting unit, in the recording unit.

65. The digital camera according to claim 57, further comprising a warning display unit for displaying the setting contents of the image conversion conditions setting unit; and
a recording unit capable of recording on a recording medium detachably mounted to the digital camera;
wherein display of the setting contents of the image conversion conditions setting unit is performed at the time of recording the recording image data, which has been subjected to image format conversion based on the setting contents of the image conversion conditions setting unit, in the recording unit.

66. The digital camera according to claim 58, further comprising a warning display unit for displaying the setting contents of the image conversion conditions setting unit; and
a recording unit capable of recording on a recording medium detachably mounted to the digital camera;
wherein display of the setting contents of the image conversion conditions setting unit is performed at the time of recording the recording image data, which has been subjected to image format conversion based on the setting contents of the image conversion conditions setting unit, in the recording unit.

67. The digital camera according to claim 59, wherein, at the time of reproducing recording image data recorded in the recording unit, the setting contents at the image conversion conditions setting unit upon image format conversion into recording image data can be displayed on the warning display unit along with the recording image data.

68. The digital camera according to claim 60, wherein, at the time of reproducing recording image data recorded in the recording unit, the setting contents at the image conversion conditions setting unit upon image format conversion into recording image data can be displayed on the warning display unit along with the recording image data.

69. The digital camera according to claim 61, wherein, at the time of reproducing recording image data recorded in the recording unit, the setting contents at the image conversion conditions setting unit upon image format conversion into recording image data can be displayed on the warning display unit along with the recording image data.

70. The digital camera according to claim 62, wherein, at the time of reproducing recording image data recorded in the recording unit, the setting contents at the image conversion conditions setting unit upon image format conversion into recording image data can be displayed on the warning display unit along with the recording image data.

71. The digital camera according to claim 63, wherein, at the time of reproducing recording image data recorded in the recording unit, the setting contents at the image conversion conditions setting unit upon image format conversion into recording image data can be displayed on the warning display unit along with the recording image data.

72. The digital camera according to claim 64, wherein, at the time of reproducing recording image data recorded in the recording unit, the setting contents at the image conversion conditions setting unit upon image format conversion into recording image data can be displayed on the warning display unit along with the recording image data.

73. The digital camera according to claim 65, wherein, at the time of reproducing recording image data recorded in the recording unit, the setting contents at the image conversion conditions setting unit upon image format conversion into recording image data can be displayed on the warning display unit along with the recording image data.

74. The digital camera according to claim 66, wherein, at the time of reproducing recording image data recorded in the recording unit, the setting contents at the image conversion conditions setting unit upon image format conversion into recording image data can be displayed on the warning display unit along with the recording image data.

75. An image format conversion method for a digital camera which sequentially performs storing of image signals sequentially image-picked-up and updating of the storage, and performs image format conversion of the stored image signals to generate through-image display image data or recording image data;
wherein image format conversion is performed such that the number of images of the recording image data generated per unit time is greater than the number of images of through-image display image data generated per unit time.

76. An image format conversion method for a digital camera which sequentially performs storing of image signals sequentially image-picked-up and updating of the storage, and performs image format conversion of the stored image signals to generate through-image display image data or recording image data;
wherein image format conversion is performed such that the number of images of the recording image data generated per unit time at the image format converting unit is increased, by reducing the number of images of through-image display image data generated per unit time at the image format converting unit.

77. An image format conversion method for a digital camera which sequentially performs storing of image signals sequentially image-picked-up and updating of the storage, and performs image format conversion of the stored image signals to generate through-image display image data or recording image data;
wherein image format conversion is performed such that the number of images of the recording image data generated per unit time in the image format converting unit and the number of images of through-image display image data generated per unit time in the image format converting unit are relatively changed.

78. An image format conversion method for a digital camera which sequentially performs storing of image signals sequentially image-picked-up and updating of the storage, and performs image format conversion of the stored image signals to generate through-image display image data or recording image data;
wherein image format conversion is performed such that, at the time of sequentially performing image format conversion of the stored image signals, a first image format conversion for performing sequential image format conversion into both the through-image display image data and the recording image data, and a second image format conversion for performing image format conversion of the stored image signals into only the recording image data, are performed in time-sequence.
